(19) United States
(12) Patent Application Publication
(10) Pub. No.: US 2025/0350120 A1
(43) Pub. Date: Nov. 13, 2025

(54) ENERGY STORAGE OPTIMIZATION

(71) Applicant: EnergyHub, Inc., Brooklyn, NY (US)

(72) Inventors: Paul Douglas Harper Hines, Burlington, VT (US); Stephanie Jean Crocker Ross, South Burlington, VT (US); William Walker Franklin, Maidens, VA (US)

(21) Appl. No.: 19/090,991

(22) Filed: Mar. 26, 2025

Related U.S. Application Data
(60) Provisional application No. 63/571,481, filed on Mar. 29, 2024.

(51) Int. Cl. H02J 3/28; H02J 3/00; H02J 7/00

(52) U.S. Cl. CPC H02J 3/28; H02J 3/003; H02J 7/0048; H02J 7/0071; H02J 2203/10; H02J 2310/54

(57) ABSTRACT

Methods, systems, and apparatus, including computer programs encoded on computer storage media, for optimizing energy storage energy flow schedules. One of the methods includes predicting a quantity of energy storage devices from a plurality of energy storage devices that will likely consume energy during a time period; for at least some devices from a plurality of energy storage devices, predicting a state of charge for the respective device; using the predicted quantity and the predicted states of charge, predicting an amount of energy that will be needed by devices from the plurality of energy storage devices during the time period; generating, using the predicted amount of energy, an energy flow schedule for one or more devices from the plurality of energy storage devices; and providing, to at least some of the one or more devices, instructions to cause the respective device to execute a respective energy flow schedule.

### CROSS REFERENCE TO RELATED APPLICATION

This application claims the benefit of U.S. Provisional Application No. 63/571,481, filed Mar. 29, 2024, the contents of which are incorporated herein by reference.

### BACKGROUND

The electrical grid comprises a variety of infrastructure components, including power stations, substations, transformers, distribution feeder cables, and transmission lines that provide energy to various energy consuming devices in different geographical regions. These infrastructure components can provide energy to the various energy consuming devices at any appropriate time, such as when electricity is plentiful or inexpensive, or demand is low or, alternatively, when electricity demand is high. Some examples of the energy consuming devices can include heating, ventilation, and air conditioning (“HVAC”) units, ovens, food cooling systems, e.g., refrigeration systems and freezing systems, energy storage devices, smart phones, and lights.

### SUMMARY

In general, one aspect of the subject matter described in this specification can be embodied in methods that include the actions of predicting a quantity of energy storage devices from a plurality of energy storage devices that will likely consume energy during a time period; for at least some devices from the plurality of energy storage devices, predicting a state of charge for the respective device; using the predicted quantity and the predicted states of charge, predicting an amount of energy that will be needed by devices from the plurality of energy storage devices during the time period; generating, using the predicted amount of energy, an energy flow schedule for one or more devices from the plurality of energy storage energy storage devices, the energy flow schedule indicating one or more time steps during which the respective device can consume energy; and providing, to at least some of the one or more devices, instructions to cause the respective device to execute a respective energy flow schedule by consuming energy during at least some of the one or more time steps indicated by the energy flow schedule.

In general, one aspect of the subject matter described in this specification can be embodied in methods that include the actions of maintaining first data that indicates i) a predicted amount of energy that will be consumed by devices from a plurality of energy storage energy storage devices during a time period and ii) a predicted state of charge for at least some devices from the plurality of energy storage energy storage devices; maintaining second data that identifies, for a physical geographical region a plurality of device groups and, for at least some of the a plurality of device groups, a respective infrastructure threshold for the respective device group; optimizing an energy flow schedule for the time period for at least some devices from the plurality of energy storage devices using at least some of the first data and at least some of the second data, the optimizing including: determining, for each of a plurality of time steps in the time period and an device group from the a plurality of device groups, a quantity of energy storage energy storage devices predicted to be able to consume energy from the device group during the respective time step using a) predicted energy requirements for other devices in the physical geographical region that are predicted to consume energy from the device group and the b) infrastructure threshold for the device group; and generating, for one or more devices from the plurality of energy storage devices predicted to need energy from the device group, an energy flow schedule that identifies a subset of the time steps from the time period during which the respective device can consume energy; and providing, to at least some of the one or more devices from the plurality of energy storage devices, instructions to cause the respective device to execute a respective energy flow schedule by consuming energy during at least some of the one or more time steps indicated by the energy flow schedule.

In general, one aspect of the subject matter described in this specification can be embodied in methods that include the actions of predicting a quantity of energy storage devices from a plurality of energy storage devices that will likely consume energy during a time period; for at least some devices from the plurality of energy storage devices, predicting a state of charge for the respective device; using the predicted quantity and the predicted states of charge, predicting a first amount of energy that will be needed by a first set of devices from the plurality of energy storage devices during the time period; using the predicted quantity and the predicted states of charge, predicting a second amount of energy that will be available from a second set of devices from the plurality of energy storage devices during the time period; generating, using the first predicted amount of energy that will be needed and the second predicted amount of energy that will be available, a) an energy flow schedule for one or more first devices from the first set of devices and b) an energy flow schedule for one or more second devices from the second set of devices, the energy flow schedule indicating one or more first time steps during which the respective device can consume energy and the energy flow schedule indicating one or more second time steps during which the respective device can provide energy; providing, to at least some of the one or more first devices, instructions to cause the respective first device to execute a respective energy flow schedule by consuming energy during at least some of the one or more first time steps indicated by the energy flow schedule; and providing, to at least some of the one or more second devices, instructions to cause the respective second device to execute a respective energy flow schedule by providing energy during at least some of the one or more second time steps indicated by the energy flow schedule.

Other implementations of this aspect include corresponding computer systems, apparatus, computer program products, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination.

In some implementations, providing the instructions can include providing, to the at least some of the one or more devices, the instructions to cause the respective device to execute a respective energy flow schedule by consuming energy during at least some of the one or more time steps indicated by the energy flow schedule and to determine to skip consumption of energy at least during time steps not indicated by the energy flow schedule. This can reduce a risk of overloading an infrastructure component.

In some implementations, generating the energy flow schedule can include generating, for a device from the plurality of energy storage devices, a corresponding energy flow schedule using the predicted amount of energy, a charge needed by time, and one or more power grid criteria. This can increase a likelihood that a charging device will consume its needed energy by the charge needed by time, reduce a risk of overloading an infrastructure component, or both.

In some implementations, predicting the amount of energy that will be needed by the device uses a minimum charge amount and the predicted state of charge for the device. This can increase a likelihood that the corresponding charging device will have access to a needed amount of energy. This can increase a likelihood that the corresponding charging device will have access to a needed amount of energy.

In some implementations, predicting the amount of energy that will be needed by the device using the one or more power grid criteria uses, as at least some of the one or more power grid criteria, a predicted amount of available energy given predicted energy consumption for other types of devices. This can increase a risk of overloading an infrastructure component given the predicted energy consumption for other types of devices.

In some implementations, the method can include predicting at least one of a plugin time or an unplug time for a device from the plurality of energy storage devices, wherein generating the energy flow schedule for the device includes: selecting one or more time steps for energy consumption by the device using the at least one of the plugin time or the unplug time; and generating, for the time period, the energy flow schedule for the device that includes the one or more time steps in the time period. This can increase a likelihood that an energy flow schedule is accurate for when a charging device plugs in, unplugs, or both.

In some implementations, the method can include determining, for at least some devices from the plurality of energy storage devices, a respective likelihood that the device will consume energy during the time period, wherein: predicting the quantity of energy storage devices from the plurality of energy storage devices that will likely consume energy during the time period uses historical data for the plurality of energy storage devices; predicting the state of charge for the respective device uses historical data for the respective device; and predicting the amount of energy that will be needed by devices from the plurality of energy storage devices during the time period includes aggregating the states of charge for each device in the plurality of energy storage devices using the respective likelihoods that the devices will consume energy. This can increase an accuracy of an energy flow schedule, reduce a risk that an infrastructure component is overloaded, or both.

In some implementations, the method can include determining, for at least some of the plurality of energy storage devices, a respective charging rate, wherein generating the energy flow schedule for the one or more devices from the plurality of energy storage devices uses the predicted amount of energy and the respective charging rates. This can increase a likelihood that a charging device will consume its needed energy by the charge needed by time, reduce a risk of overloading an infrastructure component, or both. This can increase a likelihood that a charging device consumes its needed amount of energy by its needed by time.

In some implementations, generating the energy flow schedule can include: determining, for each of a plurality of time steps in the time period and a device group from a plurality of device groups, a quantity of energy storage devices predicted to be able to consume energy from the device group during the respective time step using a) predicted energy requirements for other devices in a physical geographical region that are predicted to consume energy from the device group and b) an infrastructure threshold for the device group; and generating, for one or more devices from the plurality of energy storage devices predicted to need energy from the device group, an energy flow schedule that identifies a subset of the time steps from the time period during which the respective device can consume energy. This can reduce a risk of overloading, e.g., damaging, the infrastructure component.

In some implementations, maintaining data that identifies, for the physical geographical region, the plurality of device groups and, for at least some of the plurality of device groups, a respective infrastructure threshold for the respective device group.

In some implementations, the method includes adjusting, for at least some of the plurality of device groups, the respective infrastructure threshold for the respective device group to achieve a target adjustment.

In some implementations, the plurality of energy storage devices can include a plurality of electric vehicle charging devices.

In some implementations, the plurality of energy storage devices can include one or more of an electric vehicle charging device, a heating ventilation and air conditioning device, a water heater, or a behind-the-meter battery system.

In some implementations, the infrastructure threshold can include a power limit; and determining the quantity of energy storage devices predicted to be able to consume energy from the device group during the respective time step uses the predicted energy requirements for other devices in the physical geographical region that are predicted to consume energy from the device group and the power limit for the device group.

In some implementations, the method can include maintaining data that identifies infrastructure thresholds for the device group, each of the infrastructure thresholds for different time steps during the time period, the array of infrastructure thresholds including the infrastructure threshold, wherein: optimizing the energy flow schedule uses the array of infrastructure thresholds for the device group. This can reduce a risk of overloading the infrastructure component.

In some implementations, one or more of the infrastructure thresholds for the array of infrastructure thresholds were selected using at least one of a time of day, a predicted temperature, a predicted load, or a predicted energy usage. This can reduce of overloading an infrastructure component, when the threshold might change during different time periods.

In some implementations, the method can include determining, for the time period, whether a dynamic threshold condition is satisfied, the dynamic threshold condition indicating that the device group has a plurality of infrastructure thresholds including the infrastructure threshold instead of only a single infrastructure threshold; and determining, for the device group, the infrastructure threshold using a result of the determination whether a dynamic threshold condition is satisfied. This can reduce a risk of overloading an infrastructure component, when the threshold might change during different time periods.

In some implementations, the dynamic threshold condition can include at least one of a time of day, temperature, predicted load, actual load, predicted energy usage, or actual energy usage; and determining whether the dynamic threshold condition is satisfied includes determining whether the at least one of the time of day, the temperature, the predicted load, the actual load, the predicted energy usage, or the actual energy usage is satisfied. This can reduce a risk of overloading an infrastructure component, when the threshold might change during different time periods.

In some implementations, the method can include determining, for the time period, whether the dynamic threshold condition is satisfied includes determining, for the time period, that the dynamic threshold condition is satisfied; and determining the infrastructure threshold includes selecting, for the device group and from the plurality of infrastructure thresholds, the infrastructure threshold in response to determining, for the time period, that the dynamic threshold condition is satisfied. This can reduce a risk of overloading an infrastructure component, when the threshold might change during different time periods.

In some implementations, the method can include determining, for the time period, whether the dynamic threshold condition is satisfied includes determining, for the time period, that the dynamic threshold condition is not satisfied; and determining the infrastructure threshold includes determining, for the device group, the single infrastructure threshold in response to determining, for the time period, that the dynamic threshold condition is not satisfied. This can reduce a risk of overloading an infrastructure component, when the threshold might change during different time periods.

In some implementations, the method can include determining, for the device group, the single infrastructure threshold in response to determining, for the time period, that the dynamic threshold condition is not satisfied comprises adjusting the single infrastructure threshold such that the dynamic threshold condition is satisfied.

In some implementations, the method can include determining, for at least some devices from the second set of devices, a respective likelihood that the device will generate energy during the time period, wherein: predicting the quantity of energy storage devices from the first set of devices that will likely generate energy during the time period uses historical data for the second set of energy storage devices; predicting the state of charge for the respective device uses historical data for the respective device; and predicting the amount of energy that will be generated by devices from the second set of energy storage devices during the time period includes aggregating the states of charge for each device in the second set of energy storage devices using the respective likelihoods that the devices will generate energy.

In some implementations, the method can include determining, for at least some devices from the first set of devices, a respective likelihood that the device will consume energy during the time period, wherein: predicting the quantity of energy storage devices from the first set of devices that will likely consume energy during the time period uses historical data for the first set of energy storage devices; predicting the state of charge for the respective device uses historical data for the respective device; and predicting the amount of energy that will be needed by devices from the first set of energy storage devices during the time period includes aggregating the states of charge for each device in the first set of energy storage devices using the respective likelihoods that the devices will consume energy.

In some implementations, the first set of devices is different than the second set of devices.

In some implementations, the first set of devices and the second set of devices include at least one device in common.

In some implementations the first set of devices can include one or more of an electric vehicle charging device, a heating venting and air conditioning device, a water heater, or a behind-the-meter battery system; and the second set of devices can include one or more of an electric vehicle charging device, or a behind-the-meter battery system.

This specification uses the term “configured to” in connection with systems, apparatus, and computer program components. That a system of one or more computers is configured to perform particular operations or actions means that the system has installed on it software, firmware, hardware, or a combination of them that in operation cause the system to perform those operations or actions. That one or more computer programs is configured to perform particular operations or actions means that the one or more programs include instructions that, when executed by data processing apparatus, cause the apparatus to perform those operations or actions. That special-purpose logic circuitry is configured to perform particular operations or actions means that the circuitry has electronic logic that performs those operations or actions.

The subject matter described in this specification can be implemented in various implementations and may result in one or more of the following advantages. In some implementations, the systems and methods described in this specification can reduce a likelihood of damage to power grid infrastructure components, e.g., by using thresholds such as power limits. In some implementations, the systems and methods described in this specification can increase a likelihood of providing energy flow schedules that enable a corresponding electric vehicle to consume a needed amount of energy compared to some other systems, e.g., by generating energy flow schedules using a predicted amount of energy that will be needed by devices from a plurality of energy storage devices during a time period. In some implementations, the systems and methods described in this specification can increase a likelihood that energy storage devices get the charge they need by their need by time, e.g., using the generated energy flow schedules. In some implementations, the systems and methods described in this specification can increase a likelihood that energy storage devices have more equal access to charging resources. In some implementations, the systems and methods described in this specification, e.g., the generation of the energy flow schedule, can increase a likelihood an energy storage device will consume energy during times when energy resources are more plentiful; decrease a likelihood an energy storage device will consume energy during times when energy resources are scarce; or both.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 depicts an example environment in which a scheduling system generates an energy flow schedule for an energy storage device.

FIGS. 2A-B depict graphs for energy consumption.

FIG. 3 is a flow diagram of an example process for generating an energy flow schedule.

FIG. 4 is a block diagram of a computing system that can be used in connection with computer-implemented methods described in this specification.

Like reference numbers and designations in the various drawings indicate like elements.

### DETAILED DESCRIPTION

The power grid provides energy to various energy consuming devices including heating, ventilation, and air conditioning (“HVAC”) units, thermostats, ovens, and lights. These devices generally consume less than a threshold amount of power from a corresponding infrastructure component, such as a transformer. However, some devices, such as energy storage devices require more power to charge than other devices. An energy storage device can be an electric vehicle battery, a grid-connected battery, a behind-the-meter battery system (e.g., at a property that couples to the electric group through a connection that passes through the property's electricity meter), an electric vehicle, an electric vehicle charger, or other appropriate types of electric vehicle supply equipment.

As a result, if a sufficient quantity of these energy storage energy storage devices consume power from any particular infrastructure component during a time period, e.g., when there is generally more energy consumed by other devices, such as during the day, the amount of power might not satisfy, e.g., might exceed, the threshold amount of power for the infrastructure component which can cause physical damage to the infrastructure component. This can occur when the threshold amount defines a physical maximum amount or safe amount of power for the infrastructure component, such that, when exceeded, there is a risk that the infrastructure component will be damaged.

To predict an amount of energy that the energy storage energy storage devices might require, to determine a schedule for charging of the various energy storage devices, or both, a system can maintain historical data for energy storage devices, configuration settings, or both. The system can predict, using the historical data, a likelihood any particular energy storage device will require energy during a time period, e.g., a night, a quantity of energy storage devices that will likely need energy for the time period, or both. The system can use the quantity, and predictions about the amount of energy that an energy storage device might require, e.g., given usage of the device during the day, to predict a total amount of energy for all energy storage devices that will add load to the infrastructure component.

The system can predict, using the historical data, a likelihood that any particular energy storage device will be available to provide energy during a time period. The system can use the quantity of energy and predictions about the amount of energy that the energy storage devices will be able to provide to the power grid, to predict a total amount of energy from the energy storage devices that might be available to reduce load to the infrastructure component.

Using the predicted total amount of energy, the system can provide charging, discharging, or both, schedules to the various energy storage devices. An energy flow schedule can indicate a time step within the time period during which the respective device can consume energy, should not consume energy, or a combination of both. The system can use one or more infrastructure limits when determining the charging assignments. By using the predicted total amount of energy and the infrastructure limits, the system can reduce a likelihood that an infrastructure component will be damaged when any particular energy storage device consumes power from the power grid and one or more corresponding infrastructure components included in the power grid and that include the infrastructure component.

As used herein, the term ‘energy flow schedule’ can include charging time periods in which the respective device consume energy from the power grid, discharge time periods in which the respective device provides energy to the power grid, a generation time period in which the respective devices generates energy to provide to the power gride, or any combination of these. A single schedule might include only one time period. A schedule might include both discharging and charging time periods, e.g., when a single device can both provide energy to and consume energy from the power grid.

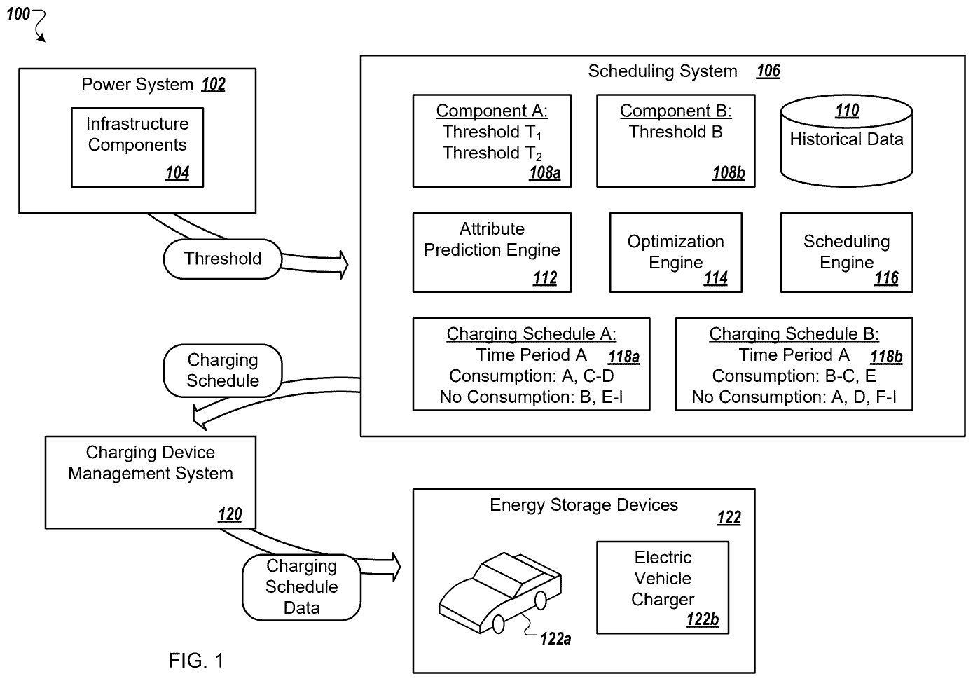

FIG. 1 depicts an example environment 100 in which a scheduling system generates an energy flow schedule for an energy storage device. A power system 102 can provide data to the scheduling system 106 to enable the scheduling system 106 to generate the energy flow schedule 118 using thresholds 108a-b, e.g., power limits, of various infrastructure components. The scheduling system 106 can provide the energy flow schedule, or instructions for the energy flow schedule, to a device management system 120, an energy storage device 122, or a combination of both, to cause the energy storage device 122 to consume energy according to the energy flow schedule.

The power system 102 includes a combination of various infrastructure components 104. These infrastructure components 104 provide energy to devices connected to the power system 102, such as energy storage devices 122 and other types of devices. Although devices that include batteries might require a certain amount of energy for a full charge, such devices cannot consume that entire amount of energy in an instant. Instead, such a device consumes energy over time, the energy consumption rate being defined as power, or an amount of energy consumed over a time unit. The time unit can be when the device is connected to the electric grid or a subset of that time.

The energy storage devices 122 can include heating and cooling elements. Some examples of such heating and cooling elements include an HVAC system which can manage thermal energy in the thermal envelope of a building such as a home, or a water heater which manages the thermal energy stored in a water tank. In some examples, the energy storage devices 122 can include energy generation devices (e.g., a heat pump, a wind turbine, a solar panel, or any combination of these) or devices coupled, directly or indirectly, to energy generation devices (e.g., a behind-the-meter battery system).

Since at least some of the infrastructure components 104 include thresholds, such as power limits, the power system 102 provides threshold data to the scheduling system 106. The power limits can define a maximum amount of power a corresponding component can transfer during a corresponding time, an amount less than the maximum amount of power, or another appropriate value. The threshold can be selected as an amount less than the maximum amount of power a corresponding component can transfer during a corresponding time to account for any uncontrollable loads that might also consume power from the corresponding component.

The scheduling system 106 maintains, in memory, the thresholds 108 and other data for the power system 102, the energy storage devices 122, or a combination of both. The other data can include historical data 110; setting data; data about the scarcity or availability of resources, e.g., rate data such as retail or wholesale rates; or a combination of two or more of these. The data about the scarcity, availability, or both, of resources, can be an average amount, e.g., a wholesale amount, an actual amount, e.g., an actual amount, or a combination of both. For instance, the historical data 110 can include, for an energy storage device 122, information for the electric vehicle connected to or that includes the corresponding energy storage device. The information can include information about when the electric vehicle plugged in to, unplugged from, or both, a power source, e.g., a charging station or another type of power source; an amount of energy used by the electric vehicle, e.g., since a last charge; an amount of time between two charging sessions; a state of charge;

a date, time, or both, of last charge; or a combination of two or more of these. A state of charge can indicate a charge level for a corresponding electric vehicle, whether the electric vehicle was charging during a particular time period, how much energy is required for a full charge, or a combination of these.

The settings data can include any appropriate type of settings data. For instance, the settings data can include a charge needed by time; a minimum charge amount; e.g., in hours, kilowatt hours (kWh), or battery percent; one or more charging time windows; or a combination of these. In some examples, the settings data can include data that defines one or more time windows during which charging should not occur, e.g., if possible. These settings can be for the power system 102. These values can be defined by a person, e.g., an owner of the corresponding electric vehicle, predicted, e.g., given historical data, or a combination of both.

In some examples, a value for a setting can be predicted given a driving schedule for the vehicle, a person who will likely use the vehicle, or a combination of both. For example, the scheduling system 106 can predict a charge needed by time using traffic data and a predicted route from a charging location of an electric vehicle and a destination location.

In some examples, a system can predict one or more settings, e.g., a need by time, using historical data. For instance, for a particular electric vehicle, the system can analyze a historical average of the electric vehicle's departure time for a given day-of-week and use data for that average departure time for the vehicle's predicted need by time. The system can add a margin of safety to the average departure time, e.g., as the data for the average departure time. For instance, when the electric vehicle typically leaves on Tuesday at 7 am, the system can determine the need-by time as 6 am. The margin can factor in some measure of variability in the departure time.

In some examples, a system can predict one or more parameters of power generation, e.g., using historical data. For instance, for an energy generating device, e.g., a solar panel, the system can analyze a historical average of the energy generating device's energy generation time for a given time period, e.g., day-of-week, or time-of-day. The system can use the power generation parameters in generating at least one energy flow schedule.

In some examples, the settings data can include one or more objectives. The objectives can be any appropriate objectives, such as objectives for the power system 102, an energy storage device 122, a charging device management system 120, or a combination of both. Some example objectives can be optimization for grid resource availability; maximizing energy resource usage when more energy resources are available, e.g., minimizing retail energy costs or wholesale energy costs; maximizing availability of clean energy, such as wind and solar; optimizing for periods of high energy generation; optimizing for grid emissions, e.g., marginal or average carbon emissions; or a combination of these. Optimizing for grid emissions can include maximizing the consumption of renewable energy, minimizing the consumption of high-emissions energy, or a combination of both.

In some implementations, the scheduling system 106 can use one or more access objectives. An access objective can be used to increase a likelihood that energy storage devices 122, e.g., a subset of the devices, have more equal access to charging resources, e.g., energy. More equal access can be defined by one or more criteria, e.g., such that no energy storage device will likely consume all needed energy resources by a larger percentage than another energy storage device. This can occur by generating energy flow schedules that do not necessarily enable a single energy storage device to consume all needed energy in one contiguous block of time steps and instead distribute energy consumption across separate time steps for multiple different energy storage devices. For instance, the electric vehicle 122a might consume energy during a first time step, the electric vehicle charger 122b might consume energy during the second and third time steps, the electric vehicle 122a might consume additional energy during the fourth time step, and the home energy storage device 122c might consume additional energy during the fifth time step. The electric vehicle 122a might not consume energy during any one of the second, third, or fourth time steps, the electric vehicle charger 122b might not consume energy during the first, fourth, and fifth time steps, or any combination of these.

As described in more detail below, the scheduling system 106 can generate the energy flow schedule for a time period. The time period can be any appropriate type of time period, such as a time horizon. In some examples, a time horizon can include multiple time periods. A day, e.g., twenty-four hours, can include multiple time periods or a single time period. The scheduling system 106 can determine a time for a time period, a duration for the time period, or a combination of both, using an energy availability, or according to a schedule, e.g., a fixed time period.

An attribute prediction engine 112 can predict, e.g., forecast, one or more attributes for an energy storage device 122. In some examples, the attribute prediction engine 112 can predict one or more attributes for, a vehicle that might consume energy using the energy storage device 122, a component that might generate energy, or a combination of these. The one or more attributes can include a state of charge, a plugin time, an unplug time, a likelihood that the vehicle will consume power during a time period, a likelihood with that an energy generation device will generate power during a time period, a discharging rate, a charging rate, attributes of the power system 102, or a combination of these, for a corresponding energy storage device.

Some examples of attributes of the power system 102 can include attributes of the various infrastructure components 104, which components are described above. In some instances, the attributes can include predicted energy supply, predicted price, predicted energy demand, or a combination of these. In some implementations, the scheduling system might receive some of the power system 102 attributes from another system, e.g., from the power system 102.

For instance, the attribute prediction engine 112 can use the historical data, setting data, or both, e.g., for a particular vehicle, to predict one or more attributes for the particular vehicle, a group of vehicles as described in more detail below, or a combination of both. The attribute prediction engine 112 can use any appropriate process to predict the one or more attributes.

In contrast to other systems that consume large amounts of energy, e.g., HVAC systems, electric vehicle use varies more widely and is harder to predict. For instance, given weather conditions, a system can predict when an HVAC will be running. But since an electric vehicle can be used at any time, which use is not necessarily a given based on external factors like weather and can change at any point, it is more difficult to predict exactly when and how much an electric vehicle will be used. By predicting an amount of energy that will be needed by a group of electric vehicles, as described in more detail below, the scheduling system 106 can increase an accuracy of energy flow schedules based on predictions of how much those electric vehicles will be used, e.g., predicted states of charge for the electric vehicles. This can improve the charging cycles of the electric vehicles; increase a likelihood that a group of electric vehicles are charged more equally when only a proper subset of the electric vehicles can charge at the same time, e.g., and not all electric vehicles can charge at the same time; can decrease a likelihood of damage to any of the infrastructure components 104; or a combination of two or more of these.

In some implementations, the attribute prediction engine 112 can use live data to predict one or more of the attributes. For instance, the attribute prediction engine 112 can use data that indicates how long the electric vehicle has been away from a primary charging location or any charging location; a received state of charge while the electric vehicle is away from a charging location, e.g., the primary charging location; or a combination of both, to predict a state of charge of the electric vehicle when the electric vehicle begins to consume energy. The primary charging location can be a “home” location, e.g., the property at which the electric vehicle primarily consumes energy. The primary charging location can be a location at which the electric vehicle consumes energy during the time period. By using data that indicates how long an electric vehicle has been away from a charging location, or has not charged, the attribute prediction engine 112 can predict a likelihood that the electric vehicle, or another type of corresponding energy storage device, will need to consume energy during a time period. For example, if an electric vehicle has not plugged in for three days, there is a higher likelihood that the electric vehicle will need more energy when it is plugged in compared to an average amount of energy needed by the electric vehicle.

The attribute prediction engine 112 can predict one or more attributes for electric vehicles at any appropriate location. For instance, the attribute prediction engine 112 can predict attributes for electric vehicles that are away from corresponding primary charging locations, at primary charging locations, or a combination of both. The attribute prediction engine 112 can predict current or future attributes for electric vehicles that are away from corresponding primary charging locations, e.g., when the scheduling system 106 does not otherwise communicate with these vehicles while the electric vehicles are away from their primary charging locations or do not otherwise send data to the scheduling system. This can enable the scheduling system 106 to generate energy flow schedules for electric vehicles when the scheduling system 106 might not have current data for those electric vehicles.

The attribute prediction engine 112 can predict one or more attributes for electric vehicles that are at their corresponding primary charging locations, that are plugged in, whether at corresponding primary charging locations or other charging locations. This can occur when the electric vehicle 122a couples with an electric vehicle charger 122b to consume energy from the power system 102. In these instances, the scheduling system 106 might not be able to directly communicate, or communicate at all, with the electric vehicle 122a. As a result, the attribute prediction engine 112 can predict the one or more attributes for the electric vehicle 122a using historical data, e.g., for the electric vehicle 122a or the electric vehicle charger 122b to which the electric vehicle 122a couples, to more accurately generate an energy flow schedule for the electric vehicle 122a.

In some implementations, the attribute prediction engine 112 can predict one or more attributes for a group of vehicles. For instance, since the prediction for any particular electric vehicle is subject to potential inaccuracy, by making a prediction for a group of vehicles, the attribute prediction engine 112 can increase an accuracy of the predicted attributes for the group of vehicles. For instance, the attribute prediction engine 112 can use the historical data for each of the electric vehicles in a group of vehicles to predict one or more attributes for the group of vehicles.

The attribute prediction engine 112 or another component of the scheduling system 106 can use any appropriate process to select a group of vehicles. For instance, the attribute prediction engine 112 can use one or more of an infrastructure group, a rate group, a region group, a vehicle status group, or a combination of these. In some examples, the attribute prediction engine 112 can use data for a group selected by another system, e.g., by a charging device management system 120.

A vehicle status group can indicate an electric vehicle charge state whether the electric vehicle is plugged in, whether the electric vehicle is unplugged, or a combination of these. In some examples, one or more of the values used to select a vehicle status group can be predicted or based on data received from a corresponding electric vehicle.

An infrastructure group is a group of energy storage devices 122 that connect to the same infrastructure component from the infrastructure components 104. The infrastructure component can be any appropriate infrastructure component. In some examples, the scheduling system 106 selects an infrastructure component using a quantity of energy storage devices 122 that consume energy using the infrastructure component. In some examples, the scheduling system 106 selects an infrastructure component using a component hierarchy, e.g., substations, feeder cables, transformers, etc.

Although some examples in this specification refer to an infrastructure group of energy storage devices, other appropriate types of groups can be used. For instance, the groups may be organized hierarchically. The groups may be divided into top level groups associated with higher load limits, and lower level groups associated with smaller load limits (e.g., which load limits are less than the top level group load limits). An optimization engine can determine the energy flow schedules to account for both the upper and lower level group load limits.

In some implementations, at least some of the groups might overlap, e.g., in ways that are not simple hierarchies. For example one group can have a group load limit for at least some properties within a certain rate class and group load limits for at least some properties in certain regions. In some examples, one group might have a group load limit for all properties within a certain rate class and certain property load limits.

A cost group can be a group of energy storage devices that have the same cost range, e.g., at a primary charging location. The cost group can be a property cost group, e.g., for a rate class (e.g., a time-of-use rate class, a dynamic rate class, a flat rate class, or a demand charge rate class), a wholesale market group, or a combination of these.

A region group can be a group of energy storage devices that are physically located in the same geographic region. A region can be defined by a locational marginal price zone or node, a city, a state, a zip code, other appropriate region information, or a combination of these.

An opt-out group can be a group of energy storage devices associated with properties who tend to opt out of device energy flow schedules, or time schedules of opt-out energy storage devices.

A thermal group can be a group of energy storage devices having similar thermal properties, e.g., that satisfy one or more thermal similarity criteria. The thermal group can be defined by a thermal inertia (e.g., a building thermal inertia), a time constant, an insulation level, a thermal conductivity, or any combination of these.

A topological group can be a group of energy storage devices associated with a topological location of an electrical grid. Examples of grid topological locations include elements connected to, or downstream from, a substation, a transformer, a distribution feeder, or any combination of these.

In examples in which the energy storage device is an electric vehicle, the scheduling system 106 can select a number of electric vehicles for a group to increase a likelihood that values for the group satisfy a grouping criteria. The grouping criteria can be any appropriate criteria, such as a distribution criteria, or a similarity criteria. For instance, for example distribution criteria, the scheduling system 106 can select electric vehicles for a group such that the predicted plugin times for the vehicles in the group are distributed, e.g., evenly, across time to satisfy a distribution criteria. For example similarity criteria, the scheduling system 106 can select electric vehicles for a group such that predicted plugin times for vehicles in the group are within a threshold distance, e.g., in the same time step.

In some implementations, the scheduling system 106 can create one or more vehicle groups such that at least some, e.g., all, of the electric vehicles 122a that are currently unplugged are aggregated into one or more groups. The groups can have simplified, aggregated charging profiles that roughly approximate the need for energy for at least some, e.g., all, vehicles in an aggregated fleet of energy storage devices.

The attribute prediction engine 112 can predict attributes for the group of electric vehicles, e.g., using data for the group of vehicles as described above. The attribute prediction engine 112 can predict, for a given time period, the needed energy for the group of vehicles. For instance, for a group of 100 vehicles, the attribute prediction engine 112 can predict that twenty electric vehicles will likely need energy during the time period, and a predicted amount of energy that will be needed by those twenty vehicles. The attribute prediction engine 112 does not need to predict the particular vehicles that will need energy but instead predicts that any subset of twenty vehicles from the 100 electric vehicles in the group will likely need energy. As a result, the scheduling system 106 can generate schedules, and budget for the corresponding energy consumption, more accurately compared to other systems.

The attribute prediction engine 112 can predict attributes for the aggregated fleet of electric vehicle charging devices. For instance, the attribute prediction engine 112 can combine aggregated predictions, individual electric vehicle charging device data, or a combination of these, e.g., using a Bayesian process. The attribute prediction engine 112 can predict the attributes for the aggregated fleet for the time period. In some examples, the aggregated attributes can include an aggregated state of charge for the devices in the group. The predicted aggregate attributes are not necessarily specific to any particular electric vehicle charging device in the aggregated fleet but can instead indicate that a certain amount of electric vehicle charging devices are predicted to plug in, plug out, consume energy, or a combination of these, at various times.

In some implementations, by generating subgroups of electric vehicle charging devices and then aggregating data for the fleet of electric vehicle charging devices, the scheduling system 106 can more accurately predict attributes for the aggregated fleet, reduce an amount of computational resources required to compute an energy flow schedule, or both. The smaller groups include proper subsets of electric vehicle charging devices from the aggregated fleet. For instance, given a finite amount of data for an electric vehicle charging device that is incomplete, does not accurately represent all details about the electric vehicle charging device, the scheduling system 106 can more accurately predict attributes about the aggregated fleet as a whole by aggregating data for the subgroups of electric vehicle charging devices. In some examples, this aggregation can also improve the accuracy of the attribute predictions when the scheduling system 106 has little to no data for electric vehicle charging devices, e.g., newly or otherwise recently connected to the system.

The scheduling system 106 can maintain weights for at least some of the historical data 110, at least some of the settings data, at least some of the attributes, or a combination of these. This historical data, settings data, and attributes can be used as input to an optimization engine 114, as described in more detail below, can generally be referred to as input data. The scheduling system 106 can use any appropriate weights that indicate a priority, or amount a corresponding subset of input data should be considered during optimization, e.g., to adjust priority among objectives for the optimization process. Input data subsets can have different types, e.g., historical data versus setting data, or other types of subsets, e.g., predicted plugin time and predicted energy needed as two subsets of attribute input data. In some examples, the scheduling system 106 can determine a weight for a corresponding input data subset. For instance, the scheduling system 106 can translate each input data type into a common unit, e.g., energy or cost. The scheduling system 106 can normalize the translated input data subsets and use the normalized to determine weights for the corresponding input data subsets during optimization.

The scheduling system 106 includes an optimization engine 114 that generates an optimization result. A scheduling engine 116 can use the optimization result to generate a dispatch plan, energy flow schedules 118, e.g., optimized energy flow schedules, or both, for at least some devices from the energy storage devices 122 given the various input data for the time period. For instance, the optimization engine 114 uses the input data to create the optimization result.

A dispatch plan can include data for multiple energy flow schedules. The multiple energy flow schedules can be for any appropriate energy storage devices. For example, the dispatch plan can be for at least some, e.g., all, energy storage devices in a group, for a single charging device management system, infrastructure component, plugged in device, unplugged device, or a combination of two or more of these.

The dispatch plan can be used by any appropriate system. For instance, the scheduling system 106 can use a dispatch plan to determine scheduling assignments for various energy storage devices 122. In some examples, a dispatch plan can be specific to a charging device management system 120. For instance, the scheduling system 106 can generate a dispatch plan that includes data for the energy flow schedules of the energy storage devices managed by a particular charging device management system 120. The scheduling system 106 can then provide data for that dispatch plan to the particular charging device management system 120, as described in more detail below.

In some implementation, the optimization result comprises raw optimization data generated by the optimization engine 114. For instance, the optimization result can include multiple numbers, e.g., in an array, according to an output format of the optimization engine 114. However, the optimization result is not necessarily formatted according to an input format for an energy storage device 122, a charging device management system 120, or both. As discussed in more detail below, the scheduling engine 116 can use the optimization result from the optimization engine 114 to generate a dispatch plan, an energy flow schedule 118, or both, that is formatted according to a predetermined format for a recipient system, device, or both.

The optimization engine 114 can use all of the various types of input data described throughout this specification or a subset of the types. For instance, the optimization engine 114 can generate an optimization result for a set of energy storage devices 122 using all of the historical data 110, all of the settings data, and all of the attributes that are for at least one vehicle in the set. In some examples, the optimization engine 114 can generate an optimization result for a set of energy storage devices 122 using a subset of the historical data 110, a subset of the settings data, and a subset of the attributes that are for at least one vehicle in the set. When any particular data from the input data is time specific, the optimization engine 114 can use the data, e.g., only the data, that applies to the corresponding time period for which the optimization result is being generated. In some examples, a utility software system (e.g., a utility grid distributed energy resource management system (DERMS)) can provide input data to the optimization engine 114. The utility grid DERMS can provide data corresponding with one or more device groups or one or more load limits, or both, to the optimization engine 114.

In examples in which the energy storage device is a battery (e.g., an electric vehicle battery, a grid connected battery, or a behind-the-meter battery system), the optimization engine 114 can include a property quality of service threshold. In some examples, the property quality of service threshold includes a limitation that no more than 20% of the total battery energy storage capacity is used from the battery to return energy to the power grid. This can include examples in which the optimization engine 114 optimizes for charging, or discharging, or both, events during charge management periods.

The scheduling engine 116 can generate a dispatch plan that might not schedule any energy storage devices 122 to consume energy during one or more steps given the various input data. For instance, when the input data includes data for when other devices are predicted to consume energy, e.g., when energy consumption is typically high such as during the day, the scheduling engine 116 might generate a dispatch plan that includes one or more instructions that indicate that no energy storage devices should consume energy for the corresponding steps, e.g., steps F through I.

A time step can be any appropriate duration of time during the time period that has a shorter duration than the time period. For instance, a step can have a duration of 15 minutes.

The dispatch plan can include multiple energy flow schedules 118a-b. An energy flow schedule for a time period, e.g., a time period A, can indicate one or more steps within the time period during which a corresponding energy storage device 122 can consume energy, should not consume energy, or both. For instance, an energy flow schedule A 118a can indicate that the corresponding energy storage device 122 can consume energy during steps A, C, and D, e.g., from a total set of steps A through I; should not consume energy during steps B, and E through I; or both. An energy flow schedule B 118b can indicate that the corresponding energy storage device 122 can consume energy during steps B, C, and E; should not consume energy during steps A, D, and F through I; or both.

The scheduling engine 116 can generate a dispatch plan, an energy flow schedule 118, or both, that is specific to one or more recipient systems and using the optimization result. For instance, the scheduling engine 116 can determine the energy storage devices 122, the charging device management systems 120, or both, to which the dispatch plan or the energy flow schedule applies. Although the remainder of this example is made with reference to an energy flow schedule for an energy storage device, similar examples apply to a dispatch plan generated for a charging device management system 120. The scheduling engine 116 can use the data that identifies the energy storage device to which the energy flow schedule applies to determine, e.g., select, a format for the energy flow schedule. For instance, different types of energy storage devices can use different formats of energy flow schedules. The scheduling system 106 can maintain a database of information for the different energy flow schedule formats. The scheduling engine 116 can then generate the energy flow schedule using the determined format.

The scheduling engine 116 can determine a format for the energy flow schedule, dispatch plan, or both, when different energy storage devices 122, different charging device management systems 120, or a combination of both, are configured to receive the data in different formats. For instance, a first charging device management system might receive dispatch plans in a first format while a second charging device management system receives dispatch plans in a second, different format. As a result, if the scheduling system 106 sent a dispatch plan to the second charging device management system in the first format, the second charging device management system would be unable to process any data for the dispatch plan.

The energy flow schedules 118 might or might not be assigned to corresponding energy storage devices. For instance, a particular energy flow schedule 118 can be assigned to a corresponding energy storage device. An assignment of an energy flow schedule 118 to an energy storage device means that if the corresponding energy storage device, or an electric vehicle for the energy storage device, plugs in, the energy storage device will receive instructions to cause the energy storage device to consume energy according to the energy flow schedule. As a result, the energy storage device should not consume energy during any time steps indicated as no energy consumption steps, might consume energy during any other time steps or time steps indicated as consumption steps, e.g., depending on energy needs, or a combination of both.

Specifically, as described in more detail below with respect to dispatch plans, the scheduling system 106 can determine energy flow schedules that are specific to corresponding energy storage devices or that are general to a category of energy storage devices. The category of energy storage devices can include devices that satisfy one or more similarity criteria, e.g., have similar attributes. For instance, a category can include multiple devices predicted to plugin during the same time step, have approximately the same energy needs, and have approximately the same need by time.

The dispatch plan can include assignments of at least some energy flow schedules 118 to corresponding energy storage devices 122. For example, when the optimization result includes assignments of energy flow schedules 118 to corresponding energy storage devices, the scheduling engine 116 can generate the dispatch plan that includes those assignments. In some examples, the scheduling engine 116 can determine assignments of energy flow schedules 118 to energy storage devices 122.

When the scheduling system 106, or another system such as a charging device management system 120, executes a dispatch plan, the scheduling system 106 sends instructions to the energy storage devices identified in the dispatch plan to cause the energy storage devices to execute the assigned energy flow schedule. This can include sending computer instructions that cause the corresponding energy storage device to consume energy according to the assigned energy flow schedule.

In some implementations, the scheduling engine 116 can generate the dispatch plan that does not necessarily include assignments of at least some energy flow schedules 118 in the dispatch plan to corresponding energy storage devices 122. This might occur when the scheduling system 106 does not have all necessary information for an energy storage device 122, e.g., when the charging device management system 120 has the necessary information and does not provide all necessary information to the scheduling system 106. In some examples, at least some of the energy flow schedules 118 can be assigned to a corresponding energy storage devices 122 when the dispatch plan is generated, e.g., the energy flow schedule B 118b can be assigned to the electric vehicle 122a when the electric vehicle 122a is coupled to a power source when the scheduling engine 116 generates the dispatch plan. Since the dispatch plan includes energy flow schedules for a quantity of energy storage devices 122 that are not currently coupled to a power source, not all of the energy flow schedules are assigned to corresponding energy storage devices 122. For example, the energy flow schedule A 118a might not be assigned to a corresponding energy storage device 122 when the dispatch plan is generated.

The scheduling engine 116 can assign some energy flow schedules 118 to energy storage devices 122 after generating the dispatch plan. For instance, when the scheduling system 106 determines that an electric vehicle has likely coupled with the electric vehicle charger 122b, the scheduling engine 116 can assign an energy flow schedule, e.g., the energy flow schedule A 118a, to the electric vehicle charger 122b, to the corresponding electric vehicle, or both.

The scheduling engine 116 can provide an energy flow schedule for use by the vehicle to which the energy flow schedule is assigned. For instance, the scheduling engine 116 can provide the energy flow schedule A 118a to the electric vehicle charger 122b, e.g., using any appropriate type of communication protocol such as a network.

In some examples, the scheduling engine 116 can provide an energy flow schedule to a charging device management system 120. A charging device management system 120 can control charging by corresponding energy storage devices 122. The charging device management system 120 can be an original equipment manufacturer system, e.g., for the manufacturer of the corresponding energy storage device 122. In these examples, the scheduling engine 116 provision of the energy flow schedule to the charging device management system 120 causes the charging device management system 120 to provide data for the energy flow schedule to the corresponding energy storage device 122. This can include the charging device management system 120 providing data representing the entire energy flow schedule to the energy storage device, providing instructions to the energy storage device for the time steps identified in the energy flow schedule to cause the energy storage device to consume energy during the time step, or a combination of both.

Receipt of the instructions or the energy flow schedule causes the energy storage device, including any corresponding battery, to consume energy during a time step. The time step is a time step identified in the energy flow schedule.

The optimization engine 114 can use any appropriate process or system to generate the optimization result. For instance, the optimization engine 114 can be a Gurobi Optimizer, a mixed integer programming problem optimizer such as those from computational infrastructure for operations research (Coin-OR), or a non-linear solver such as a basic open-source nonlinear mixed integer programming (Bonmin) solver, an Interior Point Optimizer (IPOPT) solver, a nonlinear interior point trust region optimization (KNITRO) solver, or any combination of these.

In some implementations, the optimization engine 114 can generate the optimization result that minimizes the cost of charging a group of electric vehicles over a time period, e.g., a finite time horizon, while satisfying the electric vehicles' needed energy, maintaining the group's load under a threshold, or both. Due to the uncertainty of whether a vehicle will plugin to a power source at any particular time, the optimization process can be programmed to satisfy each electric vehicle's expected value of needed energy during the time period. For instance, an electric vehicle that is plugged-in every day to charge can have an expected value for needed energy equal to the difference between its average initial energy upon plugin and its needed energy. Another electric vehicle that is plugged in once every five days can have an expected value of needed energy of ⅕th of the energy the other electric vehicle typically needs upon plugin. The scheduling engine 116 can plan an energy flow schedule for the other electric vehicle for every time period, which schedule will only provide the other electric vehicle's expected value of needed energy.

This can enable the scheduling system 106 to plan for the group's expected needed energy over the time period, e.g., in contrast to other systems that would not be able to generate as efficient a dispatch plan given more limited data, less optimized processes, or both. By planning for the group's expected energy needs over the time period, the scheduling system 106 can effectively represent the average of the many possible scenarios of plugins and energy states for at least some, e.g., all, vehicles in the group. Although the scheduling system 106 can generate a dispatch plan with energy flow schedules for at least some, e.g., all, vehicles in the group, use of the optimization engine can enable the scheduling system 106 to increase a likelihood of generating dispatch plans that enable electric vehicles to charge for a time sufficient to consume the expected value of their needed energy, e.g., and reducing a likelihood that the dispatch plan does not become infeasible because the amount of time an electric vehicle needs to charge is less for the expected value of their needed energy.

The optimization engine 114 can generate the optimization result for a group of energy storage devices (1, . . . , N_{I}), where N_{I} is the number of vehicles in the group and i is the electric vehicle index and/is the set of vehicle indices (1, . . . , N_{I}). The optimization result can optimize energy consumption for the energy storage devices over the time steps k between an initial time and end time for a time period (1, . . . , Nₖ) where K is the set of time indices (1, . . . , N_{K}). The initial time can be a current time. Nₖ can be the number of time steps from the initial time to the end time for the time period. Δₖ can be the length of the time step, e.g., in any appropriate unit such as hours.

The optimization engine 114 can use \hat{k}ᵢₙ, i to represent the time step k of estimated plug-in for the i^{th} vehicle. K_{NB,i} can represent the time step k corresponding to the need-by time for the i^{th} vehicle.

The optimization engine 114 can use Eᵢ[k] to represent the energy stored in the i^{th} electric vehicle at time step k. The time step k can have a duration of Δₜ, e.g., 15 minutes. Êᵢ[\hat{k}ᵢₙ, i] can represent the estimated stored energy of an electric vehicle upon plugin at the estimated plugin interval for the i^{th} electric vehicle. For instance, when the i^{th} electric vehicle is predicted to have Eᵢ[k] energy at plugin, the optimization engine 114 can predict an amount of energy Êᵢ[\hat{k}ᵢₙ, i] that the i^{th} electric vehicle will have at the beginning of an interval \hat{k}ᵢₙ. \hat{k}ᵢₙ can be an interval, e.g., a time step or multiple time steps, predicted to be the next interval during which the corresponding electric vehicle will plug in. Êᵢ[\hat{k}ᵢₙ, i] can be an amount of energy at the beginning of the interval, e.g., time step, that the vehicle plugs in; an average amount of energy across the interval \hat{k}ᵢₙ; a vector that indicates amounts of energy for different times in the interval \hat{k}ᵢₙ; or another appropriate amount. In some implementations, the optimization engine 114 can maximize the energy stored Eᵢ in each electric vehicle at the vehicles charge needed by time NB as Eᵢ(K_{NB,i}).

In some implementations, the optimization engine 114 can maximize the stored energy Eᵢ over each electric vehicle across all time steps. This can increase a likelihood that energy storage devices, e.g., electric vehicles, are plugged in, e.g., by penalizing last minute charging, increase a likelihood of more, e.g., fairly, distributed early charging interfaces among electric vehicles, or a combination of both.

The optimization engine 114 can use a decision variable uᵢ(k) to indicate whether electric vehicle i should charge at time step k. The decision variable uᵢ(k) can be a binary value, e.g., with one indicating that the electric vehicle i should charge and zero indicating that the electric vehicle should not charge.

In some examples, the scheduling system might only use the decision variable uᵢ(k) for electric vehicles or other energy storage devices that include batteries that have plugged in. As a result, the decision variable uᵢ(k) can be restricted, e.g., not used, before the expected plugin time. The scheduling system 106 can determine whether to use the decision variable uᵢ(k), e.g., using a status of a corresponding energy storage device.

The optimization engine 114 can use one or more weights, e.g., weighting factors α and β. As described above, the optimization engine 114 can use the weights to determine a priority for corresponding objectives. As a result, as a weight for one objective increase, the reliance on the other objectives decrease, e.g., even though the corresponding weight values may remain unchanged. One or more of the weights, or values computed using the weights, can be normalized. α can be a weighting factor for the various objectives, e.g., between three objectives that include minimizing charging cost, maximizing stored energy at needed by times, and maximizing stored energy across time steps. A higher value for a can indicate that the optimization engine 114 should generate the optimization result that maximizes an electric vehicles' stored energy at needed by times compared to other objectives. B can be a weighting factor for the various objectives, e.g., between the three objectives. A higher value for β can indicate that the optimization engine 114 should generate the optimization result that maximizes charging electric vehicles early in the time period.

The optimization engine 114 can use equation (1), below, as part of the operations to determine the optimization result. In equation (1), Cᵢ[k] can represent the availability of energy at time step k for the i^{th} vehicle. For instance, Cᵢ[k] can indicate an energy price, e.g., wholesale which can be for all charging devices or retail which can be a vehicle specific time of use rate; an amount of energy used, e.g., a percentage or another number; an amount of energy available, e.g., a percentage or another number; or a combination of two or more of these.

In equation (1), P_{c,i} can be the, e.g., typical, charging rate of the i^{th} vehicle. Uᵢ(k) can be a decision variable indicating whether the i^{th} vehicle should be charged, e.g., represented by a value such as one, or not, e.g., represented by a value such as zero, at time step k.

L_{S}[k] can indicate a surplus load, e.g., for an infrastructure component or group of infrastructure components, above the threshold Lₘₐₓ[k], described below, that is maintained for other devices that are not managed by the scheduling system 106, e.g., how much overload the power system 102 can have. As a result, L_{S}[k] can be used to prioritize or deprioritize a cost for violating the threshold Lₘₐₓ[k], e.g., the weighting factors α can be used to adjust the relative priority of the load limit constraint, e.g., Lₘₐₓ[k], while L_{S}[k] can be a measure of the degree to which the system can violate the constraints. The surplus load L_{S}[k] can be any appropriate type of value, e.g., a scalar, a vector, a time varying surplus, or another appropriate value.

$$\frac{min}{u} {\sum }_{i = 1}^{{N}_{1}} ( {\sum }_{k = 1}^{{N}_{k}} ( {C}_{i} [ k ] {Δ}_{t} {P}_{c , i} {u}_{i} [ k ] - β {E}_{i} [ k ] + α {L}_{S} [ k ] ) ) \qquad ( 1 )$$

The optimization engine can use one or more criteria, e.g., constraints, when generating the optimization result. For instance, the optimization engine can use one or more of equations (2) through (7), below, as constraints for generating the optimization result.

Equation (2), below, defines one or more load limit constraints. The load limit can maintain the base load L_{base}[k], e.g., on the power system 102, plus the aggregate charging power of the energy storage devices 122 below a threshold Lₘₐₓ[k] in each time step. The threshold, e.g., power limit, Lₘₐₓ[k] can be the load limit at time step k for the group of energy storage devices in the set I. For instance, a power system 102 might have a threshold, e.g., power limit or load limit, Lₘₐₓ[k] of 100 kW. For any given time period or step, there can be a base load L_{base}[k] of 40 KW, e.g., of uncontrollable load. In this example, the surplus load L_{S}[k] can be 60 kW, e.g., available for the energy storage devices 122 during that time period or step.

The threshold Lₘₐₓ[k] can have any appropriate unit, e.g., kW. The limit Lₘₐₓ[k] can be any appropriate type of value, e.g., a scalar, a vector, a time varying threshold, or another appropriate value. The base load L_{base}[k] can be any appropriate type of value, e.g., a scalar, a vector, a time varying threshold, or another appropriate value. Equation (2) can be ∀k∈K.

$${\sum }_{i = 1}^{{N}_{1}} ( {P}_{c , i} {u}_{i} [ k ] ) + {L}_{base} [ k ] - {L}_{S} [ k ] \leq {L}_{max [ k ]} \qquad ( 2 )$$

Equation (3), below, defines one or more energy state constraints, e.g., for the evolution of an electric vehicle state of change over time, given electric vehicle charging. The optimization engine 114 can use equation (3) as an individual model for each electric vehicle's stored energy Eᵢ. The stored energy Eᵢ can increase if the decision is to charge the electric vehicle uᵢ[k]=1 at a rate proportional to the product of the charging efficiency and the electric vehicle's typical charging power P_{c,i}. η is the efficiency with which the energy storage device charges. Equation (3) can be ∀i∈I, and for k∈K.

$${E}_{i} [ k ] + η {Δ}_{t} {P}_{c , i} {u}_{i} [ k ] = {E}_{i} [ k + 1 ] \qquad ( 3 )$$

In some implementations, the decision variable uᵢ(k) can be constrained. For instance, in Equation (4), below, ŵᵢ(k) can represent an estimate the i^{th} vehicle's plugged-in state at time step k. ŵᵢ(k) can be a binary parameter estimating whether the i^{th} vehicle will be in the plugged-in state at time step k. For plugged in vehicles, the parameter ŵᵢ(k) can have a value of one. For unplugged vehicles, the parameter ŵᵢ(k) can have a value of zero except between the estimated time of plugin and the need by time during which the parameter ŵᵢ(k) has a value of one.

ŵᵢ(k) can be conditioned on the day that the optimization engine 114 generates the optimization result is a day that the i^{th} vehicle plugs-in, e.g., historically given the historical data 110. The day can be a particular date, e.g., March 1, day of week, holiday, or some other appropriate day or type of day.

Equation (4) can increase a likelihood that a component from the environment 100 does not charge a vehicle when the vehicle is expected to be unplugged. In some examples, for the purposes of plugin state estimation, the scheduling system 106 can maintain data for two types of vehicles—those that are currently plugged in, and those that are not currently plugged in. For vehicles that are currently plugged in, the scheduling system 106 can estimate that a vehicle will be plugged in from the current time step until the vehicle's need-by time. For vehicles that are not currently plugged in, the scheduling system 106 can estimate that a vehicle will be plugged in from its median plug-in time to its plug-in time. In some examples, if the current time is past the 95^{th} percentile plug-in time, the scheduling system 106 can predict that the vehicle will not likely be plugged in at all during the time period. Equation (4) can be ∀i∈I, and for k∈K.

$${u}_{i} [ k ] \leq {\hat{w}}_{i} [ k ] \qquad ( 4 )$$

In some implementations, Equation (5) below indicates a constraint for the decision variable uᵢ(k). For instance, when constrained based on equation (5), the decision variable uᵢ(k) can be a binary value, {0,1} or a floating point value, [0,1].

$${u}_{i} [ k ] ∈ \{ 0 , 1 \} \qquad ( 5 )$$

Equation (6), below, can increase a likelihood that the stored energy of the vehicle at the expected plugin time is equal to the expected stored energy at that time. The optimization engine can use equation (6), which might only apply constraints to vehicles that have not yet plugged in. The optimization engine 114 can use, as the expected plugin, a time at which an electric vehicle has a highest probability of plugging in using data from the historical data 110. The scheduling system 106 can determine, as an electric vehicle's expected stored energy at that highest probability of plugging in time, the historical average of the electric vehicle's stored energy upon plugin at that time.

E_{target,i} can be a setting that indicates a target or needed stored energy level, e.g., in kWh, at the corresponding need-by time. For plugged in vehicles PI, Equation (6) can be ∀i∈I_{PI}.

$${E}_{i} [ {k}_{NB} ] \geq {E}_{target , i} \qquad ( 6 )$$

In some implementations, for an electric vehicle storage device that includes a battery, the corresponding expected storage is substantially the same as that device's historical average of stored energy, the scheduling system 106 can use a value for the parameter ŵᵢ. The parameter ŵᵢ can be a binary value, e.g., zero or one; a continuous value, e.g., over a range such as [0,1]; or another appropriate value. The scheduling system 106 can set the parameter; to one at vehicle i's most likely plugin time. In these implementations, the scheduling system 106 can determine a value that represents the expected number of plugins from the group of N_{I} vehicles during the time period. The scheduling system 106 can select, e.g., randomly, from the group of N_{I} vehicles, the value of vehicles, e.g., that is the same number as the expected number of plugins for the time period. The scheduling system can determine the parameter ŵᵢ for the selected vehicles, e.g., as described in more detail above.

The optimization engine 114 can use equation (7), below, to increase a likelihood of generating a more accurate optimization result, more accurate energy flow schedules, or both. In equation (7), E_{obs,t}[1] can be the observed stored energy at the current time step k=1 for the i^{th} electric vehicle. Equation (7) can be ∀i∈I_{PI}.

$${E}_{i} [ 1 ] = {E}_{obs , i} [ 1 ] \qquad ( 7 )$$

In some implementations, when the scheduling system 106 uses subgroups of energy storage devices, the optimization engine 114, the scheduling engine 116, or a combination of both, can optimize each subgroup separately. The scheduling system 106, e.g., the optimization engine 114, can do these optimizations using a smaller optimization problem, e.g., using smaller datasets specific to the energy storage devices in the corresponding subgroup. The scheduling system 106, e.g., the scheduling engine 116, can use data from the subgroup optimizations to generate the optimization result for a larger group of energy storage devices.

In some implementations, one or more of the power system 102 threshold can change over time, e.g., can have a dynamic operating envelope. For instance, a threshold for an infrastructure component from the infrastructure components can have one or more different thresholds based on a time of day, temperature, predicted load, actual load, predicted energy usage, actual energy usage, another appropriate constraint, or a combination of these. In some example thresholds, the infrastructure component can have a load limit of 20 kW from 3-5 pm local time while having a load limit of 40 kW at other times. The predicted and actual values can be for the corresponding infrastructure component, aggregate values for multiple infrastructure components, e.g., coupled to the infrastructure component, or a combination of both.

The scheduling system 106 can represent the dynamic constraints in any appropriate manner. For instance, the scheduling system 106 can use a vector of values for which each time step, or groups of time steps, have a corresponding value in the vector. In some examples, the scheduling system 106 can determine whether a dynamic threshold condition applies. If the dynamic threshold condition applies, the scheduling system 106 can select a corresponding threshold given the dynamic threshold condition. For example, the scheduling system 106 can determine whether a current time is between 3-5 pm, e.g., inclusive. If so, the scheduling system 106 can use the load limit of 20 kW for the infrastructure component. If not, the scheduling system can use the load limit of 40 kW for the infrastructure component.

In some implementations, the scheduling system 106 can determine an updated dispatch plan, energy flow schedule for an energy storage device 122, or combination of both. For instance, the time period can include multiple subperiods. A subperiod can include a time step or another appropriate unit of time. The scheduling system 106 can generate an updated energy flow schedule for a particular energy storage device 122 every subperiod or every other subperiod. By generating an updated energy flow schedule every other subperiod, the scheduling system 106 can reduce computational resource usage. The reduced computational resources can include memory, process, power, or a combination of two or more of these.

In some implementations, the scheduling system 106 might not generate an energy flow schedule for an energy storage device 122. For instance, the scheduling system 106 might initially generate a dispatch plan that includes, e.g., general, energy flow schedules that are not assigned to energy storage devices. When an electric vehicle couples with power sources, the scheduling system 106 can assign energy flow schedules to an energy storage device 122 for the electric vehicle. The energy storage device can be the electric vehicle itself or another device with which the electric vehicle couples as part of the process to couple with a power source.

Once an energy flow schedule is assigned to an energy storage device, the scheduling system 106 might not send updated energy flow schedules to the energy storage device. This can reduce network traffic used to communicate energy flow schedules, computational resources that would be required to generate the energy flow schedule for the energy storage device, or both.

In some examples, the scheduling system 106 can still generate updated energy flow schedules to replace energy flow schedules already assigned to energy storage devices. This can occur to increase a likelihood that the energy flow schedule is still optimized given any changes to the environment 100 since the energy flow schedule was generated.

Although some examples are described specifically with respect to electric vehicles 122a, these examples can apply generally to any type of energy storage device 122. For instance, the scheduling system can generate an energy flow schedule 118 for an electric vehicle charger 122b that includes a battery, e.g., a backup battery.

The power system 102, the scheduling system 106, and the charging device management system 120 are examples of systems implemented as computer programs on one or more computers in one or more locations, in which the systems, components, and techniques described in this specification are implemented. In some examples, the power system 102 can include a software system designed to manage the power system, e.g., a utility software system.

The energy storage devices 122 can include electric vehicles 122a, electric vehicle chargers 122b, electric vehicle backup batteries, other appropriate types of energy storage devices, or a combination of these. At least some of the energy storage devices 122 can send and receive data over a network. The network (not shown), such as a local area network (“LAN”), wide area network (“WAN”), the Internet, or a combination thereof, connects the power system 102, the scheduling system 106, the charging device management system 120, and the energy storage devices 122. Each of the power system 102, the scheduling system 106, and the charging device management system 120 can use a single computer or multiple computers operating in conjunction with one another, including, for example, a set of remote computers deployed as a cloud computing service.

The scheduling system 106 can include several different functional components, including the attribute prediction engine 112, the optimization engine 114, and the scheduling engine 116. The attribute prediction engine 112, the optimization engine 114, the scheduling engine 116, or a combination of these, can include one or more data processing apparatuses, can be implemented in code, or a combination of both. For instance, each of the attribute prediction engine 112, the optimization engine 114, and the scheduling engine 116 can include one or more data processors and instructions that cause the one or more data processors to perform the operations discussed herein.

The various functional components of the scheduling system 106 can be installed on one or more computers as separate functional components or as different modules of a same functional component. For example, the attribute prediction engine 112, the optimization engine 114, and the scheduling engine 116 can be implemented as computer programs installed on one or more computers in one or more locations that are coupled to each through a network. In cloud-based systems for example, these components can be implemented by individual computing nodes of a distributed computing system.

In some implementations, the optimization engine 114 can be implemented in a separate system, e.g., an optimization system (not shown). In these implementations, the scheduling system 106 can provide the optimization system with input data, e.g., as described above, and receive the optimization result in response.

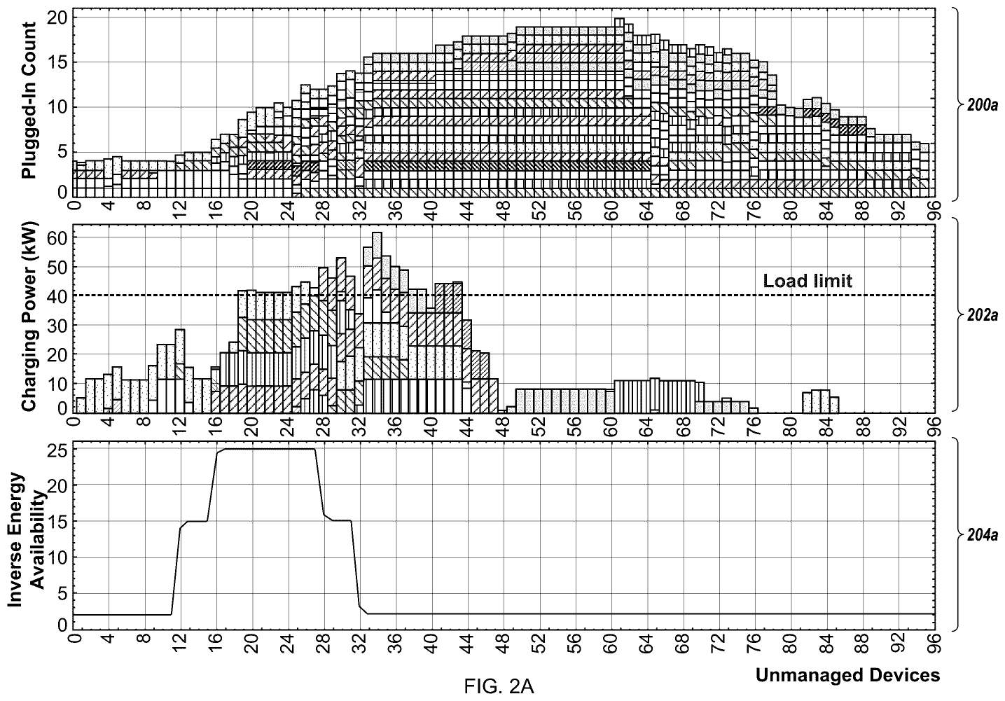

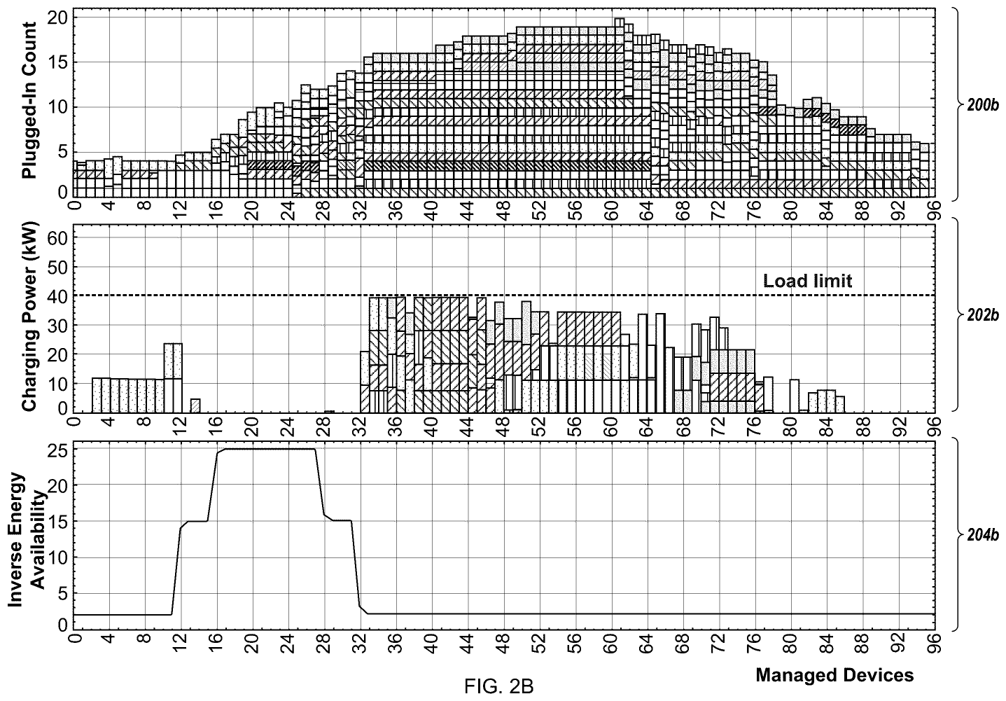

FIGS. 2A-B depict graphs for energy consumption. FIG. 2A depicts graphs for electric vehicles that are not managed by a system like the scheduling system 106 described above. Graph 200a depicts quantities of devices plugged in across time, e.g., ninety-six time steps. In graph 200a, the x-axis is shown in time increments, e.g., from 0 to 96, while the y-axis shows a plugged-in count of devices, e.g., energy storage devices. As more devices plugin, the load on the corresponding infrastructure components can increases.

As shown in graph 202a, since none of the devices are managed by the scheduling system 106 or a similar system, e.g., the devices are unmanaged, the devices begin consuming power when they are plugged in. In graph 202a, the x-axis is shown in time increments, e.g., from 0 to 96, while the y-axis shows charging power consumed by the devices, e.g., energy storage devices. As a result, there are one or more time steps during which power consumption, e.g., in kW, does not satisfy, e.g., exceeds, a corresponding infrastructure component threshold, e.g., load limit. In FIG. 2A, these one or more time steps can include at least some of the time steps from 19 to 43. As a result, there is risk that one or more of the infrastructure components might become damaged during these time steps, resulting in power loss for, e.g., all, devices that consume energy using the damaged infrastructure components.

Graph 204a indicates energy availability across time. In graph 204a, the x-axis is shown in time increments, e.g., from 0 to 96, while the y-axis shows data for an inverse of an amount of energy available, e.g., an amount of energy consumed by other devices. In graph 204a, less energy is available when the line is higher compared to the time steps during which the line is lower. This duration of time can be during daylight hours when more devices other than the energy storage devices consume energy compared to times outside of daylight hours. In some examples, the graph 204a can represent, for the amount of energy available, a rate cost for energy, e.g., in cents/kWh, which rate cost increases as more other devices consume energy. As shown in FIG. 2A, the load limit is exceeded at least some of the time during this increased energy usage time.

FIG. 2B depicts graphs for electric vehicles that are managed by a system like the scheduling system 106. As shown in graph 200b, the same quantities of devices are plugged in at the same times. Similarly, as shown in graph 204b, there is the same energy availability. In graphs 200b, 202b, and 204b, the axes have the same values as the graphs 200a, 202a, and 204a, respectively.

Since the energy storage devices of FIG. 2B are managed, graph 202b indicates that energy consumption by the energy storage devices coupled with corresponding infrastructure components does not exceed the load limit. Similarly, the energy consumption by all devices, including the other devices and the energy storage devices, does not exceed the load limit. As a result, the managed system reduces the risk of damage to the infrastructure components.

Graph 202b indicates that energy consumption by the energy storage devices is distributed across time. This can enable consumption of energy when more energy resources are available, e.g., during non-business hours; reduced cost for energy consumption; or a combination of both.

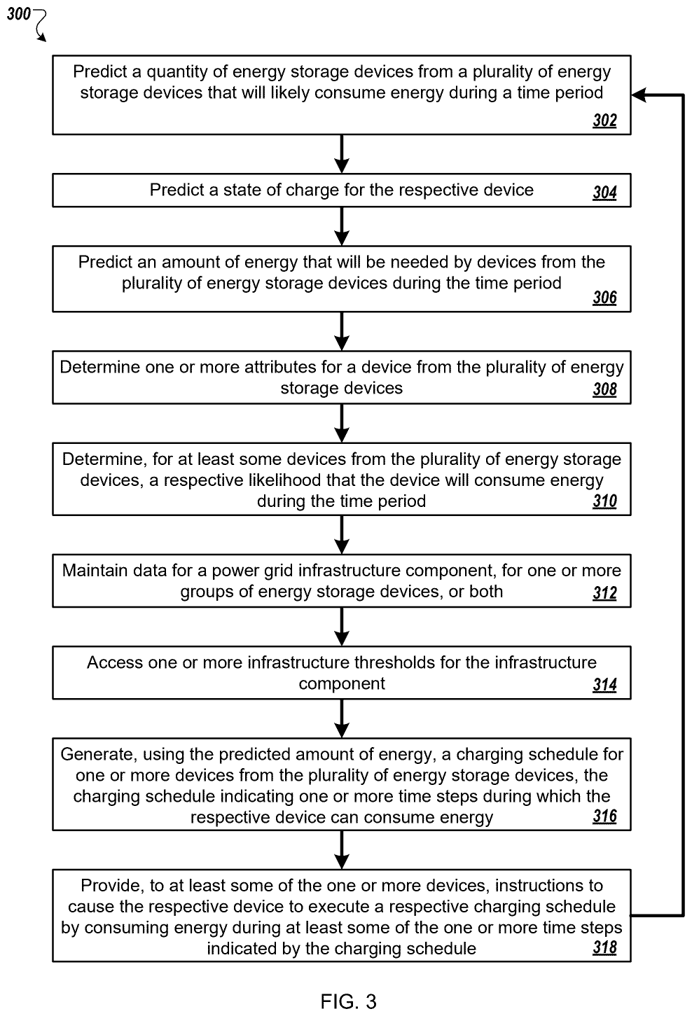

FIG. 3 is a flow diagram of an example process 300 for generating an energy flow schedule. For example, the process 300 can be used by the scheduling system 106 from the environment 100. The scheduling system 106 can perform the operations of the process 300 for a single energy storage device or a group of energy storage devices, e.g., as described in more detail above. For instance, the scheduling system 106 can perform the process 300, or a subset of operations for the process 300, for the energy storage devices that couple with an infrastructure component.

A scheduling system predicts a quantity of energy storage devices from a plurality of energy storage devices that will likely consume energy during a time period (302). The scheduling system can use historical data, other appropriate data, or a combination of both, to predict the quantity of energy storage devices that will likely consume energy during the time period. The scheduling system can use any appropriate process to make this prediction.

The scheduling system predicts a state of charge for the respective device (304). The scheduling system can use any appropriate process to make this prediction. For instance, as described in more detail above, the scheduling system can predict the state of charge.

The scheduling system predicts an amount of energy that will be needed by devices from the plurality of energy storage devices during the time period (306). The scheduling system can use any appropriate attributes for the energy storage device to predict the amount of energy that will be needed for a group of energy storage devices, e.g., a subset or a proper subset of the plurality of energy storage devices. The attributes can include a minimum charge amount, the predicted state of charge for the device, or both.

In some examples, the scheduling system can use one or more attributes of other devices or systems when predicting the amount of energy that will be needed, e.g., including one or more power grid criteria. For instance, the scheduling system can use, as at least some of the one or more power grid criteria, a predicted amount of available energy given predicted energy consumption for other types of devices. The other types of devices can include HVAC units, ovens, food cooling systems, smart phones, and lights.

In some examples, the scheduling system can use one or more attributes of other devices or systems to predict the available power for charging. The one or more attributes can include a base load L_{base}[k], a threshold Lₘₐₓ[k], or both. One or more of the attributes can have dynamic values, e.g., an array of values. Some of the values can change across time steps in the time period, e.g., can have a dynamic operating envelope.

The scheduling system determines one or more attributes for a device from the plurality of energy storage devices (308). The one or more attributes can be any appropriate attributes for the device that can be used to generate the time schedule. For instance, the one or more attributes can include at least one of a plug in time for the device, an unplug time for the device, a state of charge, a charging rate, or a combination of two or more of these. As described above, the scheduling system can determine the one or more attributes for a vehicle or multiple vehicles. In some examples, the scheduling system can determine the one or more attributes for a group of vehicles, at least some, e.g., all, vehicles, or a combination of both.

The scheduling system determines, for at least some devices from the plurality of energy storage devices, a respective likelihood that the device will consume energy during the time period (310). The scheduling system can determine the respective likelihood using any appropriate data. For instance, the scheduling system can determine the respective likelihood using historical data for a respective device, one or more attributes for the respective device, calendar information that indicates when an electric vehicle might be used, or a combination of these. The calendar information can include data for calendars of one or more people who might use the electric vehicle, e.g., people in the same household as a primary user of the electric vehicle. The scheduling system can use the calendar information to predict when the electric vehicle might be used. The scheduling system can use a result of the prediction, and any other appropriate data, to determine the respective likelihood.

In some examples, the scheduling system can determine the likelihood using one or more of a plugin time, an unplug time, a state of charge, or a combination of these. The scheduling system can use the plugin time, the unplug time, the state of charge, or a combination of these to determine an estimated needed energy for the time period. The scheduling system can use the estimated needed energy to determine the likelihood.

The scheduling system maintains data for a power grid infrastructure component (312). The data can be any appropriate type of data for generating an energy flow schedule, such as data that identifies one or more infrastructure thresholds, data that indicates the availability or scarcity of energy resources, e.g., generally referred to as the availability of energy resources, one or more groups of infrastructure components, or a combination of these. The thresholds can include any appropriate thresholds such as a power limit for a corresponding infrastructure component.

In some implementations, the thresholds can include a “snapback limiting threshold”. The snapback limiting threshold can limit an amount of sudden charging load that one gets after the end of a high resource availability time, e.g., reducing a likelihood of potential overloads from electric vehicle charging. A system, e.g., the charging system or the power system, can determine the snapback limiting threshold, e.g., automatically without human input, using the maximum load and the extent to which the maximum load can be spread over time, historical data, or a combination of both. The historical data can include any appropriate historical data such as a number of vehicles that are plugged in during certain time periods; historical energy usage; telemetry or forecast data, such as an amount of energy needed to satisfy the needed charge for all vehicles by their need-by times; or a combination of two or more of these.

In some examples, the scheduling system can maintain data for one or more groups of energy storage devices. For instance, as described in more detail above, the scheduling system can determine groups of energy storage devices, receive data identifying groups of energy storage devices, or a combination of both. The scheduling system can maintain data representing the groups in memory, e.g., in a database.

The scheduling system accesses one or more infrastructure thresholds for the infrastructure component (314). For instance, when the scheduling system maintains a scalar or a vector for the one or more infrastructure thresholds for the infrastructure component in a database, along with infrastructure threshold for other infrastructure components, the scheduling system can select the one or more infrastructure thresholds for the infrastructure component and retrieve the infrastructure thresholds for the database.

When the one or more infrastructure thresholds include values for times, the times can be time steps or any other appropriate time during the time period. The values can be the same value, e.g., when the infrastructure component has a single infrastructure threshold, or at least some different values. The different infrastructure thresholds can be determined using one or more of a time of day; a predicted temperature, e.g., of the infrastructure component or another location; a predicted load, e.g., for the infrastructure component; a predicted energy usage, e.g., for devices that consume energy using the infrastructure component; or a combination of two or more of these.

In some examples, when the scheduling system uses a scalar for the infrastructure threshold, the scheduling system can determine whether a dynamic threshold condition is satisfied. For instance, the scheduling system determines whether an infrastructure component has multiple thresholds. The thresholds can be for any appropriate condition, e.g., time of day, current power consumption by devices coupled, e.g., indirectly, to the infrastructure component, or another appropriate condition.

The scheduling system can select, from a plurality of infrastructure thresholds, an infrastructure threshold. The scheduling system can select the infrastructure threshold in response to determining that the dynamic threshold condition is satisfied. The scheduling system can use the dynamic threshold condition to select the infrastructure threshold. For instance, when the dynamic threshold condition specifies one or more times of day to which a corresponding threshold applies, the scheduling system can select the infrastructure threshold when generating an energy flow schedule for a time period that overlaps, at least in part, with the one or more times of day.

In some examples, the scheduling system can select multiple infrastructure thresholds. For example, when each of the multiple infrastructure thresholds correspond to the time period, the scheduling system can select the multiple infrastructure thresholds. This can occur when a single dynamic threshold condition that identifies two or more of the multiple infrastructure thresholds is satisfied, when multiple dynamic threshold conditions each of which identify at least one infrastructure threshold are satisfied, or a combination of both.

The scheduling system can determine, for the infrastructure component, a single infrastructure threshold. The scheduling system can determine the single infrastructure threshold in response to determining that the dynamic threshold condition is not satisfied, or when an infrastructure component only has the single infrastructure threshold, e.g., and no dynamic threshold conditions.

The scheduling system generates, using the predicted amount of energy, an energy flow schedule for one or more devices from the plurality of energy storage devices, the energy flow schedule indicating one or more time steps during which the respective device can consume energy (316).

In some instances, the scheduling system can select one or more time steps for energy consumption by the device using one or more attributes. For example, the scheduling system can select a time step using a plugin time, an unplug time, or both. The time step can be after a plugin time, before an unplug time, or a combination of both. The scheduling system can generate the energy flow schedule that includes the selected one or more time steps.

In some implementations, generating the energy flow schedule can include optimizing the energy flow schedule. Optimizing or generating the energy flow schedule can use the infrastructure threshold, e.g., power limit, such as a vector of infrastructure thresholds.

In some examples, generating the energy flow schedule can use one or more attributes for a corresponding energy storage device. For instance, the scheduling system can generate, for a device from the plurality of energy storage devices, a corresponding energy flow schedule using the predicted amount of energy, a charge needed by time, and one or more power grid criteria. The power grid criteria can include a grouping criteria, an optimization criteria, e.g., including an infrastructure threshold, any other appropriate type of criteria, or a combination of these.

The scheduling system provides, to at least some of the one or more devices, instructions to cause the respective device to execute a respective energy flow schedule by consuming energy during at least some of the one or more time steps indicated by the energy flow schedule (318). The instructions can be any appropriate instructions. For example, the instructions can be included in a message that the scheduling system transmits to a corresponding energy storage device. The message can include data for the entire energy flow schedule or a portion of the energy flow schedule.

In some implementations, the scheduling system transmits at least some of the instructions to a charging device management system for a corresponding energy storage device. For instance, when the charging device management system manages power consumption of corresponding energy storage devices, e.g., a fleet of charging devices, the scheduling system can transmit the instructions to the charging device management system for the devices managed by the management system. This can cause the management system to send appropriate instructions to the managed charging devices to cause the managed charging devices to consume energy according to the energy flow schedule.

In some implementations, one or more of the thresholds can be adjusted by the system automatically to reduce the maximum load from a group of energy storage devices. This can reduce stress on power grid infrastructure. A DERMS software system operated by a utility might not have all the details of grid infrastructure limits. However, the system might receive input from an operator of the utility grid indicating an attempt to minimize peak energy storage device charging in certain locations by a minimum threshold, as much as possible, or another appropriate value. This can be to avoid damaging one or more grid infrastructure components by operating at a load limit that is above the maximum load for the infrastructure component. References to a maximum load in this specification can refer to a predicted maximum load or an actual (e.g., known) maximum load.

In some examples, a power grid limit for a group of energy storage devices is set. The power grid limit may be based on the number of energy storage devices, the typical load levels for each respective energy storage device of the group of energy storage devices, the rated power limits of infrastructure components, or any combination of these. The typical load levels for a group of energy storage devices may be determined by measuring the actual peak load levels from the group of energy storage devices over a time period, e.g., multiple days. The typical load levels may be calculated using a weighted average of the actual peak load levels measured from the group of energy storage devices over the time.

The system may store or otherwise maintain a high load limit, a low load limit, or both for the group of devices. The system may adjust the load limit to a higher limit if the calculated weighted average of the load levels exceeds the load limit by an amount. The system may adjust the load limit down to a lower limit if the calculated weighted average of the load levels is below the load limit by an amount. If the optimizer engine 114 is not able to build a schedule that can keep the net load below the load limit, the system may adjust the load limit up.

The system may adjust one or more load limits to account for devices that may be offline, not controllable, or both. Adjusting the load limits to account for these devices may result in a schedule that adjusts determined load limits while accounting for devices that are uncontrollable, or predicted to be uncontrollable, by the system. In some examples, the load limits may be reduced to account for some of the energy storage devices that are not responsive, not automatically controllable by the system, or both. In some examples, an additional uncontrollable load variable can be added to the optimization engine 114 so that the optimization engine 114 can adjust accordingly.

The order of operations in the process 300 described above is illustrative only, and generating the energy flow schedule can be performed in different orders. For example, the operations 302 through 314 can be performed in any appropriate order. Operation 314 can be performed before or after any of operations 302 through 312.

In some implementations, the process 300 can include additional operations, fewer operations, or some of the operations can be divided into multiple operations. For example, the process 300 can include operations 302, 304, 306, 316, and 318, e.g., without any of the other operations in the process 300 or with a proper subset of the other operations. In some examples, the process 300 can include operations 312, 316, and 318, e.g., without any of the other operations in the process 300 or with a proper subset of the other operations. This can include operation 314. These examples can include the maintenance of additional data, e.g., a predicted amount of energy, a predicted state of charge, or both.

In some implementations, the scheduling system can perform the process 300 multiple times. For instance, after providing instructions to cause execution of an energy flow schedule, the scheduling system can gather data about the execution of the energy flow schedule; execution of other energy flow schedules, e.g., as part of execution of a dispatch plane; other energy storage devices, e.g., not included in the dispatch plan; or a combination of two or more of these. The scheduling system determine that a waiting period is satisfied, and to predict another quantity of energy storage devices that will likely consume energy in a subsequent time period. The subsequent time period can be a time period that at most partially overlaps with the time period, i.e., the two periods do not have the same start and end times though they might have the same duration. For example, the subsequent time period can begin a predetermined number of time steps after the time period.

In these implementations, one or more of the operations for the subsequent time period might not be performed. For instance, the scheduling system need not maintain the data for the power grid infrastructure component, data for the one or more groups of energy storage devices, or both. This can occur since such maintenance of the data is ongoing.

For situations in which the systems discussed here collect personal information about users, or may make use of personal information, the users may be provided with an opportunity to control whether programs or features collect personal information (e.g., information about a user's schedule, a vehicle's driving history, a user's preferences, or a user's current location), or to control whether and/or how the scheduling system uses that personal information to generate a schedule. In addition, certain data may be anonymized in one or more ways before it is stored or used, so that personally identifiable information is removed. For example, a user's identity may be anonymized so that no personally identifiable information can be determined for the user, or a user's geographic location may be generalized where location information is obtained (such as to a city, ZIP code, or state level), so that a particular location of a user cannot be determined. Thus, the user may have control over how information is collected about him or her and used.

In this specification, the term “database” is used broadly to refer to any collection of data: the data does not need to be structured in any particular way, or structured at all, and it can be stored on storage devices in one or more locations. A database can be implemented on any appropriate type of memory.

In this specification the term “engine” is used broadly to refer to a software-based system, subsystem, or process that is programmed to perform one or more specific functions. Generally, an engine will be implemented as one or more software modules or components, installed on one or more computers in one or more locations. In some instances, one or more computers will be dedicated to a particular engine. In some instances, multiple engines can be installed and running on the same computer or computers.

A number of implementations have been described. Nevertheless, it will be understood that various modifications can be made without departing from the spirit and scope of the disclosure. For example, various forms of the flows shown above can be used, with operations re-ordered, added, or removed.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible non-transitory program carrier for execution by, or to control the operation of, a data processing apparatus. Alternatively or in addition, the program instructions can be encoded on an artificially-generated propagated signal, e.g., a machine-generated electrical, optical, or electromagnetic signal, that is generated to encode information for transmission to a suitable receiver apparatus for execution by a data processing apparatus. One or more computer storage media can include a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can be or include special purpose logic circuitry, e.g., a field programmable gate array (“FPGA”) or an application-specific integrated circuit (“ASIC”). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can be performed by, and apparatus can also be implemented as, special purpose logic circuitry, e.g., a field programmable gate array (“FPGA”) or an application-specific integrated circuit (“ASIC”).

Computers suitable for the execution of a computer program include, by way of example, general or special purpose microprocessors or both, and any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. A computer can be embedded in another device, e.g., a mobile telephone, a smart phone, a headset, a personal digital assistant (“PDA”), a mobile audio or video player, a game console, a Global Positioning System (“GPS”) receiver, or a portable storage device, e.g., a universal serial bus (“USB”) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a liquid crystal display (“LCD”), an organic light emitting diode (“OLED”) or other monitor, for displaying information to the user and a keyboard and a pointing device, e.g., a mouse or a trackball or a touchscreen, by which the user can provide input to the computer. Other kinds of devices can be used to provide for interaction with a user as well. For example, feedback provided to the user can be any form of sensory feedback, e.g., visual feedback, auditory feedback, or tactile feedback; and input from the user can be received in any form, including acoustic, speech, or tactile input. In some examples, a computer can interact with a user by sending documents to and receiving documents from a device that is used by the user; for example, by sending web pages to a web browser on a user's device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, e.g., a Hypertext Markup Language (“HTML”) page, to a user device, e.g., for purposes of displaying data to and receiving user input from a user device, which acts as a client. Data generated at the user device, e.g., a result of user interaction with the user device, can be received from the user device at the server.

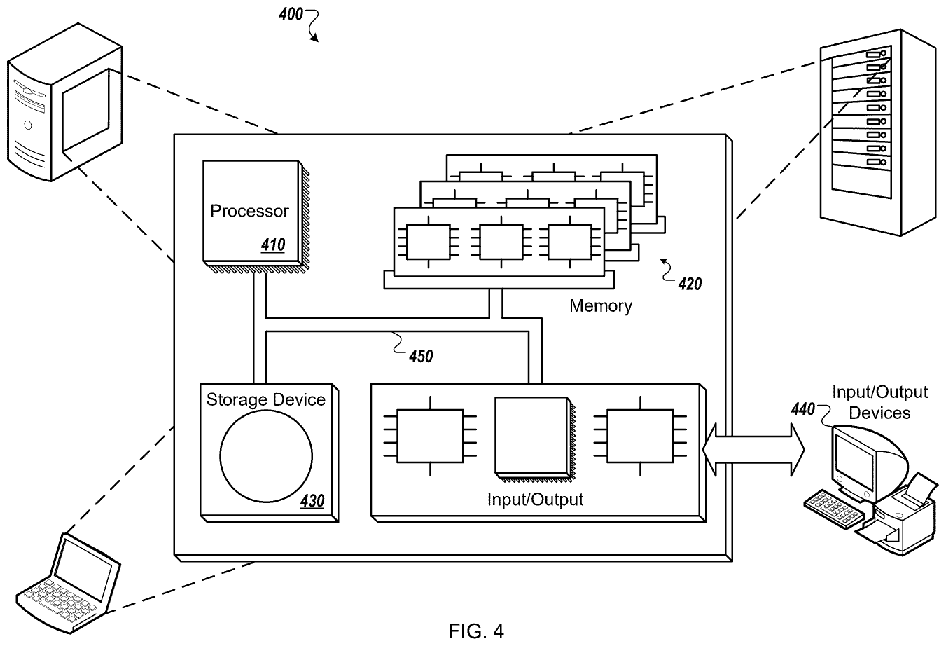

An example of one such type of computer is shown in FIG. 4, which shows a schematic diagram of a computer system 400. The computer system 400 can be used for the operations described in association with any of the computer-implemented methods described previously, according to some implementations. The computer system 400 includes a processor 410, a memory 420, a storage device 430, and an input/output device 440. Each of the components 410, 420, 430, and 440 are interconnected using a system bus 450. The processor 410 is capable of processing instructions for execution within the computer system 400. In one implementation, the processor 410 is a single-threaded processor. In another implementation, the processor 410 is a multi-threaded processor. The processor 410 is capable of processing instructions stored in the memory 420 or on the storage device 430 to display graphical information for a user interface on the input/output device 440.

The memory 420 stores information within the computer system 400. In some implementations, the memory 420 is a computer-readable medium. In some implementations, the memory 420 is a volatile memory unit. In some implementations, the memory 420 is a non-volatile memory unit.

The storage device 430 is capable of providing mass storage for the computer system 400. In some implementations, the storage device 430 is a computer-readable medium. In some implementations, the storage device 430 can be a floppy disk device, a hard disk device, an optical disk device, or a tape device.

The input/output device 440 provides input/output operations for the computer system 400. In some implementations, the input/output device 440 includes a keyboard, a pointing device, a touchscreen, or a combination of these. In some implementations, the input/output device 440 includes a display unit for displaying graphical user interfaces. In some implementations, the input/output device 440 includes a microphone, a speaker, or a combination of both.

While this specification contains many specific implementation details, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some instances be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures, such as spreadsheets, relational databases, or structured files, may be used.

Particular implementations of the invention have been described. Other implementations are within the scope of the following claims. For example, the operations recited in the claims, described in the specification, or depicted in the figures can be performed in a different order and still achieve desirable results. In some implementations, multitasking and parallel processing may be advantageous.

What is claimed is:

1. A computer-implemented method comprising:
predicting a quantity of energy storage devices from a plurality of energy storage devices that will likely consume energy during a time period;
for at least some devices from the plurality of energy storage devices, predicting a state of charge for the respective device;
using the predicted quantity and the predicted states of charge, predicting an amount of energy that will be needed by devices from the plurality of energy storage devices during the time period;
generating, using the predicted amount of energy, an energy flow schedule for one or more devices from the plurality of energy storage energy storage devices, the energy flow schedule indicating one or more time steps during which the respective device can consume energy; and
providing, to at least some of the one or more devices, instructions to cause the respective device to execute a respective energy flow schedule by consuming energy during at least some of the one or more time steps indicated by the energy flow schedule.

2. The method of claim 1, wherein providing the instructions comprises providing, to the at least some of the one or more devices, the instructions to cause the respective device to execute a respective energy flow schedule by consuming energy during at least some of the one or more time steps indicated by the energy flow schedule and to determine to skip consumption of energy at least during time steps not indicated by the energy flow schedule.

3. The method of claim 1, wherein generating the energy flow schedule comprises generating, for a device from the plurality of energy storage devices, a corresponding energy flow schedule using the predicted amount of energy, a charge needed by time, and one or more power grid criteria.

4. The method of claim 3, wherein predicting the amount of energy that will be needed by the device using the one or more power grid criteria uses, as at least some of the one or more power grid criteria, a predicted amount of available energy given predicted energy consumption for other types of devices.

5. The method of claim 1, comprising:
predicting at least one of a plugin time or an unplug time for a device from the plurality of energy storage devices, wherein generating the energy flow schedule for the device comprises:
selecting one or more time steps for energy consumption by the device using the at least one of the plugin time or the unplug time; and
generating, for the time period, the energy flow schedule for the device that includes the one or more time steps in the time period.

6. The method of claim 1, comprising determining, for at least some devices from the plurality of energy storage devices, a respective likelihood that the device will consume energy during the time period, wherein:
predicting the quantity of energy storage devices from the plurality of energy storage devices that will likely consume energy during the time period uses historical data for the plurality of energy storage devices;
predicting the state of charge for the respective device uses historical data for the respective device; and
predicting the amount of energy that will be needed by devices from the plurality of energy storage devices during the time period comprises aggregating the states of charge for each device in the plurality of energy storage devices using the respective likelihoods that the devices will consume energy.

7. The method of claim 1, comprising:
determining, for at least some of the plurality of energy storage devices, a respective charging rate,
wherein generating the energy flow schedule for the one or more devices from the plurality of energy storage devices uses the predicted amount of energy and the respective charging rates.

8. The method of claim 1, wherein generating the energy flow schedule comprises:
determining, for each of a plurality of time steps in the time period and a device group from a plurality of device groups, a quantity of energy storage devices predicted to be able to consume energy from the device group during the respective time step using a) predicted energy requirements for other devices in a physical geographical region that are predicted to consume energy from the device group and b) an infrastructure threshold for the device group; and
generating, for one or more devices from the plurality of energy storage devices predicted to need energy from the device group, an energy flow schedule that identifies a subset of the time steps from the time period during which the respective device can consume energy.

9. The method of claim 8, comprising maintaining data that identifies, for the physical geographical region, the plurality of device groups and, for at least some of the plurality of device groups, a respective infrastructure threshold for the respective device group, and adjusting, for at least some of the plurality of device groups, the respective infrastructure threshold for the respective device group to achieve a target adjustment.

10. The method of claim 1, wherein the plurality of energy storage devices comprises one or more of an electric vehicle charging device, a heating ventilation and air conditioning device, a water heater, or a behind-the-meter battery system.

11. A system comprising one or more computers and one or more storage devices on which are stored instructions that are operable, when executed by the one or more computers, to cause the one or more computers to perform operations comprising:
maintaining first data that indicates i) a predicted amount of energy that will be consumed by devices from a plurality of energy storage energy storage devices during a time period and ii) a predicted state of charge for at least some devices from the plurality of energy storage energy storage devices;
maintaining second data that identifies, for a physical geographical region a plurality of device groups and, for at least some of the a plurality of device groups, a respective infrastructure threshold for the respective device group;
optimizing an energy flow schedule for the time period for at least some devices from the plurality of energy storage devices using at least some of the first data and at least some of the second data, the optimizing comprising:
determining, for each of a plurality of time steps in the time period and an device group from the a plurality of device groups, a quantity of energy storage energy storage devices predicted to be able to consume energy from the device group during the respective time step using a) predicted energy requirements for other devices in the physical geographical region that are predicted to consume energy from the device group and the b) infrastructure threshold for the device group; and
generating, for one or more devices from the plurality of energy storage devices predicted to need energy from the device group, an energy flow schedule that identifies a subset of the time steps from the time period during which the respective device can consume energy; and
providing, to at least some of the one or more devices from the plurality of energy storage devices, instructions to cause the respective device to execute a respective energy flow schedule by consuming energy during at least some of the one or more time steps indicated by the energy flow schedule.

12. The system of claim 11, wherein:
the infrastructure threshold comprises a power limit; and
determining the quantity of energy storage devices predicted to be able to consume energy from the device group during the respective time step uses the predicted energy requirements for other devices in the physical geographical region that are predicted to consume energy from the device group and the power limit for the device group.

13. The system of claim 11, comprising:
maintaining, in memory, an array of infrastructure thresholds for the device group, each of the infrastructure thresholds for different time steps during the time period, the array of infrastructure thresholds including the infrastructure threshold, wherein:
optimizing the energy flow schedule uses the array of infrastructure thresholds for the device group.

14. The system of claim 11, comprising:
determining, for the time period, whether a dynamic threshold condition is satisfied, the dynamic threshold condition indicating that the device group has a plurality of infrastructure thresholds including the infrastructure threshold instead of only a single infrastructure threshold; and
determining, for the device group, the infrastructure threshold using a result of the determination whether a dynamic threshold condition is satisfied.

15. The system of claim 14, wherein:
the dynamic threshold condition comprises at least one of a time of day, temperature, predicted load, actual load, predicted energy usage, or actual energy usage; and
determining whether the dynamic threshold condition is satisfied comprises determining whether the at least one of the time of day, the temperature, the predicted load, the actual load, the predicted energy usage, or the actual energy usage is satisfied.

16. The system of claim 14, wherein:
determining, for the time period, whether the dynamic threshold condition is satisfied comprises determining, for the time period, that the dynamic threshold condition is satisfied; and
determining the infrastructure threshold comprises selecting, for the device group and from the plurality of infrastructure thresholds, the infrastructure threshold in response to determining, for the time period, that the dynamic threshold condition is satisfied.

17. The system of claim 14, wherein:
determining, for the time period, whether the dynamic threshold condition is satisfied comprises determining, for the time period, that the dynamic threshold condition is not satisfied; and
determining the infrastructure threshold comprises determining, for the device group, the single infrastructure threshold in response to determining, for the time period, that the dynamic threshold condition is not satisfied.

18. One or more computer storage media encoded with instructions that, when executed by one or more computers, cause the one or more computers to perform operations comprising:
predicting a quantity of energy storage devices from a plurality of energy storage devices that will likely consume energy during a time period;
for at least some devices from the plurality of energy storage devices, predicting a state of charge for the respective device;
using the predicted quantity and the predicted states of charge, predicting a first amount of energy that will be needed by a first set of devices from the plurality of energy storage devices during the time period;
using the predicted quantity and the predicted states of charge, predicting a second amount of energy that will be available from a second set of devices from the plurality of energy storage devices during the time period;
generating, using the first predicted amount of energy that will be needed and the second predicted amount of energy that will be available, a) an energy flow schedule for one or more first devices from the first set of devices and b) an energy flow schedule for one or more second devices from the second set of devices, the energy flow schedule indicating one or more first time steps during which the respective device can consume energy and the energy flow schedule indicating one or more second time steps during which the respective device can provide energy;
providing, to at least some of the one or more first devices, instructions to cause the respective first device to execute a respective energy flow schedule by consuming energy during at least some of the one or more first time steps indicated by the energy flow schedule; and
providing, to at least some of the one or more second devices, instructions to cause the respective second device to execute a respective energy flow schedule by providing energy during at least some of the one or more second time steps indicated by the energy flow schedule.

19. The computer storage media of claim 18, comprising determining, for at least some devices from the second set of devices, a respective likelihood that the device will generate energy during the time period, wherein:
predicting the quantity of energy storage devices from the first set of devices that will likely generate energy during the time period uses historical data for the second set of energy storage devices;
predicting the state of charge for the respective device uses historical data for the respective device; and
predicting the amount of energy that will be generated by devices from the second set of energy storage devices during the time period comprises aggregating the states of charge for each device in the second set of energy storage devices using the respective likelihoods that the devices will generate energy.

20. The computer storage media of claim 18, comprising determining, for at least some devices from the first set of devices, a respective likelihood that the device will consume energy during the time period, wherein:
predicting the quantity of energy storage devices from the first set of devices that will likely consume energy during the time period uses historical data for the first set of energy storage devices;
predicting the state of charge for the respective device uses historical data for the respective device; and
predicting the amount of energy that will be needed by devices from the first set of energy storage devices during the time period comprises aggregating the states of charge for each device in the first set of energy storage devices using the respective likelihoods that the devices will consume energy.
